(19) United States
(12) Patent Application Publication
(10) Pub. No.: US 2025/0175979 A1
(43) Pub. Date: May 29, 2025

(54) TIMING CONTROL IN WIRELESS COMMUNICATIONS

(71) Applicant: Lenovo (Singapore) Pte. Limited, Singapore (SG)

(72) Inventors: Joachim Löhr, Wiesbaden (DE); Prateek Basu Mallick, Dreieich (DE); Ravi Kuchibhotla, Chicago, IL (US)

(73) Assignee: Lenovo (Singapore) Pte. Limited, Singapore (SG)

(21) Appl. No.: 18/992,464

(22) PCT Filed: Jul. 6, 2023
(86) PCT No.: PCT/IB2023/057016

§ 371 Date: Jan. 8, 2025

Related U.S. Application Data
(60) Provisional application No. 63/359,383, filed on Jul. 8, 2022.

(51) Int. Cl. H04W 72/1268; H04W 72/231; H04W 76/28

(52) U.S. Cl. CPC H04W 72/1268; H04W 72/231; H04W 76/28

(57) ABSTRACT

Various aspects of the present disclosure relate to methods, apparatuses, and systems that support timing control in wireless communications. For instance, implementations provide enhanced scheduling by a network entity to increase wireless resource efficiency as well as capacity, such as for extended reality (XR) traffic. For example, where DRX ActiveTimes of different DRX configurations overlap and where discontinuous reception (DRX) timer values of different DRX configurations are different, implementations provide ways for notifying user equipment (UE) of timer configuration information. Further, implementations are provided for configuring transmission of scheduling requests (SR) by UEs, such as to enable UEs to delay sending SR to avoid excessive extension of active times. Still further, implementations are provided for configuring dynamic adaptation of DRX timers, such as for enabling UEs to determine conditions under which to update DRX timers.

### RELATED APPLICATION

This application claims priority to U.S. Patent Application Ser. No. 63/359,383 filed 8 Jul. 2022 entitled “TIMING CONTROL IN WIRELESS COMMUNICATIONS,” the disclosure of which is incorporated by reference herein in its entirety.

### TECHNICAL FIELD

The present disclosure relates to wireless communications, and more specifically to timing control in wireless communications.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communications systems provide ways for configuring different timers related to wireless communications, such as timers pertaining to discontinuous reception (DRX). Such systems, however, may implement static timer configurations that do not adapt to different data traffic types.

### SUMMARY

The present disclosure relates to methods, apparatuses, and systems that support timing control in wireless communications. For instance, implementations provide enhanced scheduling by a network entity to increase wireless resource efficiency as well as capacity, such as for extended reality (XR) traffic. Where DRX ActiveTimes of different DRX configurations overlap and where DRX timer values of different DRX configurations are different, for example, implementations provide ways for notifying UEs of timer configuration information. Further, implementations are provided for configuring transmission of scheduling requests (SR) by UEs, such as to enable UEs to delay sending SR to avoid extension of active times. Still further, implementations are provided for configuring dynamic adaptation of DRX timers, such as for enabling UEs to determine conditions under which to update DRX timers.

By utilizing the described techniques, timer configuration can be controlled and can thus reduce power consumption (e.g., by UEs) and reduce signaling overhead, such as for UEs and network entities.

Some implementations of the methods and apparatuses described herein may further include receiving, at a first time instance, downlink control information (DCI) allocating a set of resources for a hybrid automatic repeat request (HARQ) process, where the DCI includes a field indicating whether to start a timer; and starting, at a second time instance, the timer based at least in part on the field indicating to start the timer.

Some implementations of the methods and apparatuses described herein may further include: where the DCI is allocating a set of downlink resources for a HARQ process; where the second time instance is a first symbol after an end of a transmission carrying HARQ feedback for a downlink transmission allocated by the DCI; where the timer is a drx-HARQ-RTT-TimerDL (where RTT is round trip time); where the timer is a drx-HARQ-RTT-TimerUL; where the timer is a drx-inactivityTimer; where the second time instance is a first symbol after an end of reception of the DCI; where the DCI further includes an indication of whether HARQ feedback is enabled or disabled; where the DCI further includes an indication that if a packet delay budget (PDB) is below a threshold, the timer is not to be started; where the DCI further includes an indication that after a transmission associated with the downlink resources, an apparatus is to transition to a sleep mode; where the DCI further includes an indication of an end of a data burst after which the timer is not to be started.

Some implementations of the methods and apparatuses described herein may further include receiving a notification identifying a wireless resource and a DRX configuration; selecting, based on the DRX configuration, a DRX timer from multiple different DRX timers; and configuring the DRX timer.

Some implementations of the methods and apparatuses described herein may further include: where the notification includes a DRX configuration identifier; where the notification is received as part of DCI; where the notification includes multiple DRX configurations, the method further including starting two or more of the multiple DRX timers that correspond to the multiple DRX configurations; where the notification includes multiple DRX configurations and indicates one or more of a search space or a control resource set (CORESET) for each of the DRX configurations; where the notification includes multiple DRX configurations, the method further including applying a predefined rule based on the multiple DRX configurations to determine which of the multiple DRX timers to start.

Some implementations of the methods and apparatuses described herein may further include receiving a notification identifying a maximum delay time for sending a scheduling request; and transmitting a scheduling request at a time instance determined based at least in part on the maximum delay time.

Some implementations of the methods and apparatuses described herein may further include applying the maximum delay time to delay the scheduling request until the time instance; where the maximum delay time is based at least in part on a remaining PDB; when an apparatus is in an active DRX state, transmitting the scheduling request before expiry of a scheduling request timer configured based at least in part on the maximum delay time; and when an apparatus is in an inactive DRX state, transmitting the scheduling request after expiry of the scheduling request timer.

Some implementations of the methods and apparatuses described herein may further include receiving a notification including configuration information indicating whether to start one or more timers in response to a physical uplink shared channel (PUSCH) transmitted on a HARQ process; and operating, based on the configuration information, the one or more timers in response to PUSCH transmitted on the HARQ process.

Some implementations of the methods and apparatuses described herein may further include: where the one or more timers include a drx-HARQ-RTT-TimerUL timer; where the configuration information further specifies one or more of whether to monitor physical downlink control channel (PDCCH) for a retransmission grant, or to perform a HARQ transmission on PUSCH; where the configuration information includes: a first HARQ process configuration for which the one or more timers are to be started in response to PUSCH transmitted on the HARQ process; and a second HARQ process configuration for which the one or more timers are not to be started in response to PUSCH transmitted on the HARQ process; where operating the one or more timers in response to PUSCH transmitted on the HARQ process includes: starting the one or more timers based on the first HARQ process configuration; or not starting the one or more timers based on the second HARQ process configuration.

Some implementations of the methods and apparatuses described herein may further include receiving a notification including configuration information including an uplink configured grant (CG) and an indication of whether to start one or more timers in response to uplink transmission on the uplink CG; and operating, based on the configuration information, the one or more timers in response to an uplink transmission on the uplink CG.

Some implementations of the methods and apparatuses described herein may further include: where the one or more timers include one or more of a drx-HARQ-RTT-TimerUL timer or a drx-RetransmissionTimerUL timer; where the configuration information includes an indication that the one or more timers are not to be started in response to uplink transmission of a particular data type on the uplink CG; where the configuration information includes one or more timer values to be applied to the one or more timers in response to the uplink transmission on the uplink CG; where operating the one or more timers in response to the uplink transmission on the uplink CG includes applying the one or more timer values to the one or more timers; where the configuration information includes an uplink CG configuration for XR data transmission on the uplink CG; applying the uplink CG configuration for XR data transmission to the uplink CG; and transmitting XR data on the uplink CG configured for XR data transmission.

Some implementations of the methods and apparatuses described herein may further include generating DCI allocating a set of resources for a HARQ process, where the DCI includes a field indicating whether to start a timer; and transmitting the DCI to a UE.

Some implementations of the methods and apparatuses described herein may further include: where the timer is a drx-HARQ-RTT-TimerDL; where the timer is a drx-inactivity Timer; where the DCI further includes an indication of whether HARQ feedback is enabled or disabled; where the DCI further includes an indication that if a PDB is below a threshold, the timer is not to be started; where the DCI further includes an indication that after a transmission associated with the downlink resources, an apparatus is to transition to a sleep mode; where the DCI further includes an indication of an end of a data burst after which the timer is to be started.

Some implementations of the methods and apparatuses described herein may further include generating a notification identifying a wireless resource and a DRX configuration; and transmitting the notification to a UE.

Some implementations of the methods and apparatuses described herein may further include: where the notification includes a DRX configuration identifier; where the notification is transmitted as part of DCI; where the notification includes multiple DRX configurations; where the notification includes multiple DRX configurations and indicates one or more of a search space or a CORESET for each of the DRX configurations.

Some implementations of the methods and apparatuses described herein may further include generating a notification identifying a maximum delay time for sending a scheduling request; and transmitting the notification to a UE.

Some implementations of the methods and apparatuses described herein may further include: where the maximum delay time is based at least in part on a remaining PDB; where the notification further includes instructions indicating that: when the UE is in an active DRX state, to transmit the scheduling request before expiry of a scheduling request timer configured based at least in part on the maximum delay time; and when the UE is in an inactive DRX state, to transmit the scheduling request after expiry of the scheduling request timer.

Some implementations of the methods and apparatuses described herein may further include generating a notification including configuration information indicating whether to start one or more timers in response to a PUSCH transmitted on a HARQ process; and transmitting the notification to a UE.

Some implementations of the methods and apparatuses described herein may further include: where the one or more timers include a drx-HARQ-RTT-TimerUL timer; where the configuration information further specifies one or more of whether to monitor PDCCH for a retransmission grant, or to perform a HARQ transmission on PUSCH; where the configuration information includes: a first HARQ process configuration for which the one or more timers are to be started in response to PUSCH transmitted on the HARQ process; and a second HARQ process configuration for which the one or more timers are not to be started in response to PUSCH transmitted on the HARQ process.

Some implementations of the methods and apparatuses described herein may further include generating a notification including configuration information including an uplink CG and an indication of whether to start one or more timers in response to uplink transmission on the uplink CG; and transmitting the notification to a UE.

Some implementations of the methods and apparatuses described herein may further include: where the one or more timers include one or more of a drx-HARQ-RTT-TimerUL timer or a drx-RetransmissionTimerUL timer; where the configuration information includes an indication that the one or more timers are not to be started in response to uplink transmission of a particular data type on the uplink CG; where the configuration information includes one or more timer values to be applied to the one or more timers in response to the uplink transmission on the uplink CG; where the configuration information includes an uplink CG configuration for XR data transmission on the uplink CG.

Some implementations of the methods and apparatuses described herein may further include receiving a notification including configuration information including an uplink configured grant (CG) configuration and an indication of whether to start one or more timers in response to an uplink transmission on physical uplink shared channel (PUSCH) resources of the uplink configured grant configuration; and operating, based on the configuration information, the one or more timers in response to an uplink transmission on the CG PUSCH resources; the one or more timers include one or more of a drx-HARQ-RTT-TimerUL timer or a drx-RetransmissionTimerUL timer; the configuration information includes an indication that the one or more timers are not to be started in response to the uplink transmission on the CG PUSCH resources; the configuration information includes an indication that one or more timers are not be started in a first symbol after an end of the PUSCH transmission.

Some implementations of the methods and apparatuses described herein may further include generating a notification including configuration information including an uplink configured grant (CG) configuration and an indication of whether to start one or more timers in response to an uplink transmission on physical uplink shared channel (PUSCH) resources of the uplink configured grant configuration; and transmitting the notification to a UE; the one or more timers include one or more of a drx-HARQ-RTT-TimerUL timer or a drx-RetransmissionTimerUL timer; the configuration information includes an indication that the one or more timers are not to be started in response to the uplink transmission on the CG PUSCH resources.

### BRIEF DESCRIPTION OF THE DRAWINGS

FIG. 1 illustrates an example of a wireless communications system that supports timing control in wireless communications in accordance with aspects of the present disclosure.

FIG. 2 illustrates an example of multiple data streams such as for carrying XR traffic.

FIG. 3 illustrates an example of multiple data streams such as for carrying XR traffic.

FIGS. 4 and 5 illustrate different respective portions of an information element (IE) that supports timing control in wireless communications in accordance with aspects of the present disclosure.

FIGS. 6 and 7 illustrate examples of block diagrams of devices that support timing control in wireless communications in accordance with aspects of the present disclosure.

FIGS. 8 through 18 illustrate flowcharts of methods that support timing control in wireless communications in accordance with aspects of the present disclosure.

### DETAILED DESCRIPTION

In wireless communications systems, different types of data traffic can exhibit different characteristics, such as packet size, traffic periodicity, packet types, etc. For instance, XR traffic characteristics include features such as variable packet arrival rate (e.g., packets arriving at 30-120 frames per second with some jitter), packets having variable and large packet size, B/P-frames being dependent on I-frames, presence of multiple traffic/data flows such as pose and video scene in uplink, and so forth. Further, latency parameters of XR traffic on a radio access network (RAN) side (e.g., air interface) can be modelled as PDB. The PDB, for instance, is a time budget for a packet to be transmitted over the air from a network entity (e.g., gNB) to a UE. A delay budget can be also defined for an application data unit (ADU).

When considering end-user XR devices, such devices are often mobile and of small-scale, and thus may have limited battery power resources. The current DRX mechanism is a power saving mechanism intended to achieve power saving gain for UE in RRC_CONNECTED state. However, some characteristics of XR traffic are not addressed by the current DRX mechanism and may limit UE power savings. For example, a single DRX configuration may not be efficient from power saving perspective since as discussed above, some traffic types (e.g., XR traffic) exhibit differing characteristics which cannot be accurately covered by a single DRX configuration. Further, in some wireless communications implementations for DRX, a UE may extend an ActiveTime in response to the reception of a PDCCH, such as in scenarios where there are no impending HARQ retransmissions (e.g., due to the PDB) and/or no impending initial transmissions, e.g., for a last packet of a protocol data unit (PDU) set.

Accordingly, this disclosure provides for techniques that support timing control in wireless communications. For instance, implementations provide enhanced scheduling by a network entity to increase wireless resource efficiency as well as capacity, such as for XR traffic. For instance, where DRX ActiveTimes of different DRX configurations overlap and/or where DRX timer values of different DRX configurations are different, implementations provide ways for notifying UEs of timer configuration information. Further, implementations are provided for configuring transmission of SR by UEs, such as to enable UEs to delay sending SR to avoid excessive extension of active times. Still further, implementations are provided for configuring dynamic adaptation of DRX timers, such as for enabling UEs to determine conditions under which to update DRX timers.

Accordingly, implementations provide signaling (e.g., via DCI) to enable a network entity to dynamically control whether a UE is to start DRX-related timers, such as based on whether follow up transmissions may occur. Further, an uplink configured CG configuration is provided that includes an IE indicating whether uplink (UL) transmissions on the CG resources are to trigger the starting of different timers. For instance, for CG configurations used for XR traffic with tight latency requirements, a UE is instructed to not monitor PDCCH for potential retransmission grants, e.g., DCI with configured scheduling (CS)-radio network temporary identifier (RNTI).

Thus, by utilizing the described techniques, UE power consumption and signaling overhead between UEs and network entities can be reduced.

Aspects of the present disclosure are described in the context of a wireless communications system. Aspects of the present disclosure are further illustrated and described with reference to device diagrams and flowcharts.

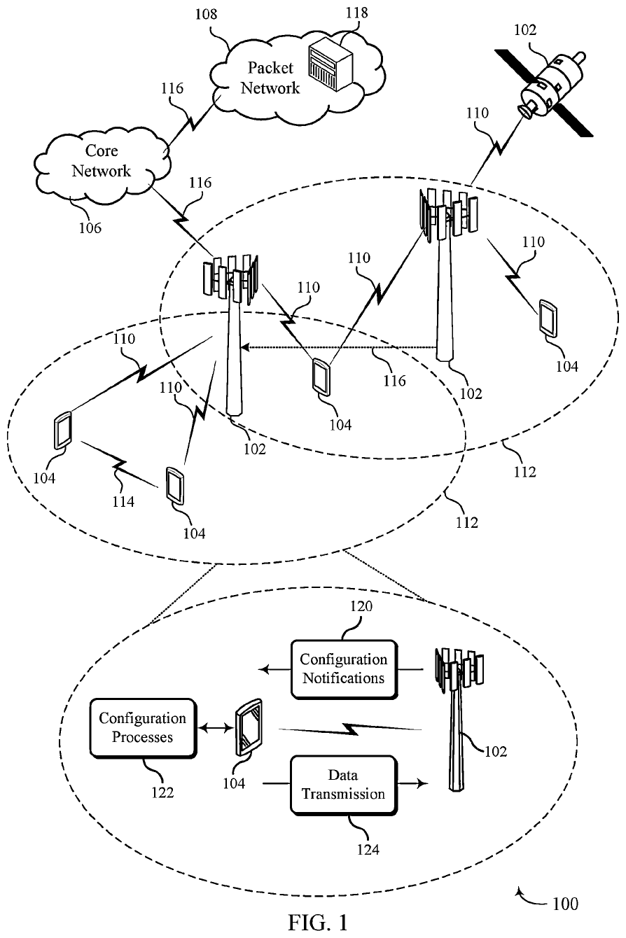

FIG. 1 illustrates an example of a wireless communications system 100 that supports timing control in wireless communications in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a RAN, a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-real time (RT) RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, MAC layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a PDU session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (e.g., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHz), FR4 (52.6 GHZ-114.25 GHZ), FR4a or FR4-1 (52.6 GHZ-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for timing control in wireless communications, a network entity 102 can generate configuration notifications 120 and communicate the configuration notifications 120 to a UE 104. The configuration notifications 120, for instance, include timing-related information such as for DRX-related timers, timing for sending scheduling requests, and so forth. In at least one implementation the configuration notifications 120 include CG resources. Based on configuration information in the configuration notifications 120, the UE 104 performs configuration processes 122. As part of the configuration processes 122, for instance, the UE 104 configures and/or operates different timers, such as DRX-related timers, timing related to transmitting SR, timers related to HARQ processes, and so forth. Further, the UE 104 can perform data transmission 124 based at least on one or more timers. The data transmission 124, for instance, can include various types of data transmission, such as PUSCH transmission, SR transmission, HARQ-related transmission, and so forth.

XR is an umbrella term used to refer to different types of realities including:
Virtual reality (VR) is a rendered version of a delivered visual and audio scene. The rendering is designed to mimic the visual and audio sensory stimuli of the real world as naturally as possible to an observer or user as they move within the limits defined by the application. Virtual reality usually, but not necessarily, is implemented where a user wears a head mounted display (HMD) to replace the user's field of view with a simulated visual component, and wears headphones to provide the user with accompanying audio. Some form of head and motion tracking of the user in VR is usually implemented to allow the simulated visual and audio components to be updated in order to ensure that, from the user's perspective, items and sound sources remain consistent with the user's movements. Additional means to interact with the virtual reality simulation may be provided but are not strictly necessary.
Augmented reality (AR) is when a user is provided with additional information or artificially generated objects or content overlaid upon their current environment. Such additional information or content will usually be visual and/or audible and their observation of their current environment may be direct, with no intermediate sensing, processing and rendering, or indirect, where their perception of their environment is relayed via sensors and may be enhanced or processed.
Mixed reality (MR) is an advanced form of AR where some virtual elements are inserted into the physical scene with the intent to provide the illusion that these elements are part of the real scene.

Thus, XR can be used to refer to all real-and-virtual combined environments and human-machine interactions generated by computer technology and wearables. Further, XR includes representative forms such as AR, MR and VR and the areas interpolated among them. The levels of virtuality range from partially sensory inputs to fully immersive VR. An example aspect of XR is the extension of human experiences especially relating to the senses of existence (e.g., as represented by VR) and the acquisition of cognition, e.g., as represented by AR.

Accordingly, XR services, such as AR, VR, and Cloud Gaming services over 5G are important vertical applications for wireless commercial deployments. Many of the end user XR and Cloud Gaming devices are designed to be mobile and of small-scale, thus having limited battery power resources. The current DRX mechanism is a power saving mechanism to achieve power saving gain for UE in RRC_CONNECTED state. However, some characteristics of XR traffic are not addressed by the current DRX mechanism and may result in limited UE power savings.

Implementations have been proposed to have multiple DRX configurations which are aligned with the different XR streams. A motivation for this, for instance, is that a single DRX configuration is not efficient from power saving perspective since traffic characteristics are too different and aren't addressed by a single DRX configuration.

With a single data flow for the UE, if the DRX periodicity matches the traffic arrival of that data flow, dynamic grant can be used as the main means to support XR traffic. However, XR use cases do not typically involve a single data flow: for example, for VR, there is video data flow in the downlink (DL) and pose/control data flow in the UL with different periodicities. For AR, two data flows in the DL (video, audio/data) and three data flows in the UL (video, pose/control, audio/data) with different periodicities can be present. Thus, it can be difficult to select periodicity and on-time to address possible data flows. Further, supporting non-integer periodicity for DRX may fail to provide benefit for UE power saving.

Further, when there are multiple data flows, such as when at least integer relationship does not exist among their periodicities, matching DRX's periodicity to another data flow's periodicity may cause data flow arrival in DRX-Off duration.

Support of video traffic is particularly important in the context of XR traffic. For instance, video traffic exhibits characteristics such as non-integer periodicity (e.g., video traffic at 60, 90 and 120 frames/second) and time-varying packet size, such as due to different frame types, e.g., I-frames, P-frames, B-frames, etc.

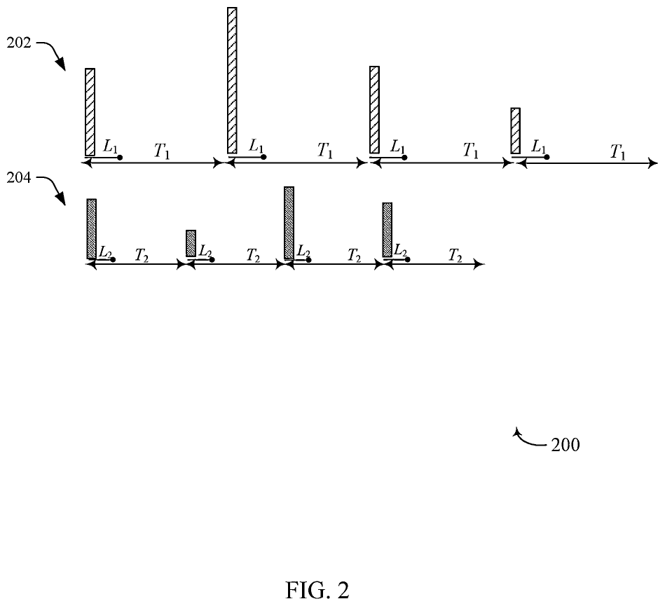

FIG. 2 illustrates at 200 an example of multiple data streams such as for carrying XR traffic. For instance, a data stream 202 carries video traffic and exhibits periodic time intervals T₁, and a data stream 204 carries audio traffic and exhibits periodic time intervals T₂. As illustrated, the data streams 202, 204 exhibit differing periodicities.

As video frames can be generated at regular time epochs, DL semi-persistent scheduling (SPS) and UL configured grant can be considered primary candidates to accommodate XR traffic in general, and video traffic in particular. However, the Rel-16 NR design has some limitations. Note the DL SPS periodicity and UL configured grant periodicity available in Rel-16 (such as illustrated at 200) do not correlate with aspects of video traffic including:
Supported periodicity for DL SPS in Rel-16 NR:
   {1, . . . , 640} milliseconds for a NR system at 15 kilohertz (KHz) subcarrier spacing,
   {½, 1, 3/2, . . . , 640} milliseconds at 30 KHz, etc.
Supported periodicities for UL configured grant in Rel-16 NR:
   Multiple of 1 millisecond for 15 KHz up to 640 milliseconds, 2 symbols ( 1/7 milliseconds), 7 symbols (0.5 milliseconds)
   Multiple of ½ millisecond for 30 KHz up to 640 milliseconds, 2 symbols ( 1/14 milliseconds), 7 symbols (0.25 milliseconds)
With video frames generated at 30, 60, 90, 120 Hz, out of many periodicities supported currently in NR for SPS and Cloud Gaming, appropriate matches may not be realized.

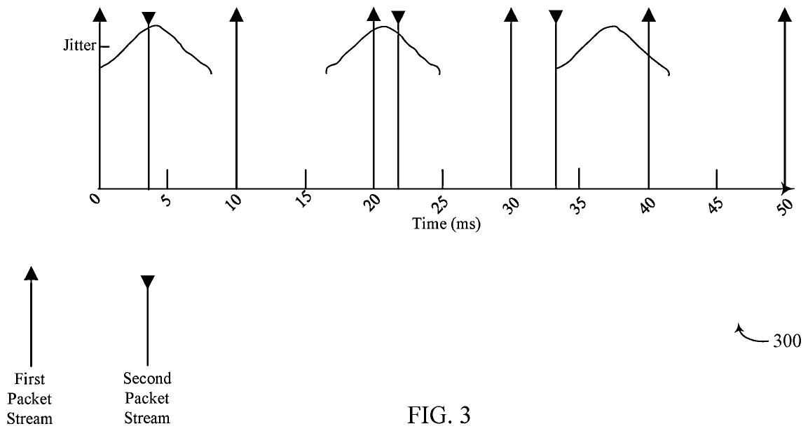

FIG. 3 illustrates example data streams 300 such as for carrying XR traffic. For instance, the data stream 300 includes packet arrival times for packets of a first data stream and packets of a second data stream, as well as jitter that can occur between the arrival times such as due to differing packet periodicities.

In considering DRX such in XR scenarios for some wireless communications systems, a MAC entity may be configured by RRC with a DRX functionality that controls a UE's PDCCH monitoring activity for the MAC entity's cell @-RNTI, cell identifier (CI)-RNTI, CS-RNTI, interruption (INT)-RNTI, slot format indication (SFI)-RNTI, semi-persistent (SP)-channel state information (CSI)-RNTI, transmit power control (TPC)-physical uplink control channel (PUCCH)-RNTI, TPC-PUSCH-RNTI, TPC-SRS-RNTI, and air interface (AI)-RNTI. When using DRX operation, the MAC entity may also monitor PDCCH according to parameters found in other clauses of this specification. When in RRC_CONNECTED, if DRX is configured for activated Serving Cells, the MAC entity may monitor the PDCCH discontinuously using the DRX operation specified in this clause; otherwise, the MAC entity shall monitor the PDCCH as specified in technical specification (TS) 38.213 [6].

An RRC can control DRX operation by configuring the following parameters:
drx-onDurationTimer: the duration at the beginning of a DRX cycle.
drx-SlotOffset: the delay before starting the drx-onDuration Timer.
drx-InactivityTimer: the duration after the PDCCH occasion in which a PDCCH indicates a new UL or DL transmission for the MAC entity.
drx-Retransmission TimerDL (per DL HARQ process except for the broadcast process): the maximum duration until a DL retransmission is received.
drx-RetransmissionTimerUL (per UL HARQ process): the maximum duration until a grant for UL retransmission is received.
drx-LongCycleStartOffset: the Long DRX cycle and drx-StartOffset which defines the subframe where the Long and Short DRX cycle starts.
drx-ShortCycle (optional): the Short DRX cycle.
drx-ShortCycle Timer (optional): the duration the UE shall follow the Short DRX cycle.
drx-HARQ-RTT-TimerDL (per DL HARQ process except for the broadcast process): the minimum duration before a DL assignment for HARQ retransmission is expected by the MAC entity.
drx-HARQ-RTT-TimerUL (per UL HARQ process): the minimum duration before a UL HARQ retransmission grant is expected by the MAC entity.
ps-Wakeup (optional): the configuration to start associated drx-onDurationTimer in case data convergence protocol (DCP) is monitored but not detected.
ps-TransmitOtherPeriodicCSI (optional): the configuration to report periodic CSI that is not L1-reference signal received power (RSRP) on PUCCH during the time duration indicated by drx-onDurationTimer in case DCP is configured but associated drx-onDurationTimer is not started.
ps-TransmitPeriodicL1-RSRP (optional): the configuration to transmit periodic CSI that is L1-RSRP on PUCCH during the time duration indicated by drx-onDuration Timer in case DCP is configured but associated drx-onDuration Timer is not started.

Further, Serving Cells of a MAC entity may be configured by RRC in two DRX groups with separate DRX parameters. When RRC does not configure a secondary DRX group, there may be one DRX group and all Serving Cells belong to that one DRX group. When two DRX groups are configured, each Serving Cell may be uniquely assigned to either of the two groups. The DRX parameters that are separately configured for each DRX group are: drx-onDurationTimer, drx-InactivityTimer. The DRX parameters that are common to the DRX groups are: drx-SlotOffset, drx-Retransmission TimerDL, drx-Retransmission Timer UL, drx-LongCycleStartOffset, drx-ShortCycle (optional), drx-ShortCycle Timer (optional), drx-HARQ-RTT-TimerDL, and drx-HARQ-RTT-Timer UL. When DRX is configured, the Active Time for Serving Cells in a DRX group includes the time while:
drx-onDurationTimer or drx-InactivityTimer configured for the DRX group is running; or
drx-RetransmissionTimerDL or drx-RetransmissionTimer UL is running on any Serving Cell in the DRX group; or
ra-ContentionResolutionTimer (as described in clause 5.1.5) or msgB-Response Window (as described in clause 5.1.4a) is running; or
a Scheduling Request is sent on PUCCH and is pending; or
a PDCCH indicating a new transmission addressed to the C-RNTI of the MAC entity has not been received after successful reception of a Random Access Response for the Random Access Preamble not selected by the MAC entity among the contention-based Random Access Preamble.

According to some scenarios, when DRX is configured, the MAC entity is to:
1> if a MAC PDU is received in a configured downlink assignment:
   2> start the drx-HARQ-RTT-TimerDL for the corresponding HARQ process in the first symbol after the end of the corresponding transmission carrying the DL HARQ feedback;
   2> stop the drx-Retransmission TimerDL for the corresponding HARQ process.
1> if a MAC PDU is transmitted in a configured uplink grant and listen before talk (LBT) failure indication is not received from lower layers:
   2> start the drx-HARQ-RTT-TimerUL for the corresponding HARQ process in the first symbol after the end of the first transmission (within a bundle) of the corresponding PUSCH transmission;
   2> stop the drx-Retransmission Timer UL for the corresponding HARQ process at the first transmission (within a bundle) of the corresponding PUSCH transmission.
1> if a drx-HARQ-RTT-TimerDL expires:
   2> if the data of the corresponding HARQ process was not successfully decoded:
      3> start the drx-RetransmissionTimerDL for the corresponding HARQ process in the first symbol after the expiry of drx-HARQ-RTT-TimerDL.
1> if a drx-HARQ-RTT-TimerUL expires:
   2> start the drx-Retransmission TimerUL for the corresponding HARQ process in the first symbol after the expiry of drx-HARQ-RTT-TimerUL.
1> if a DRX Command media access control (MAC) control element (CE) or a Long DRX Command MAC CE is received:
   2> stop drx-onDuration Timer for each DRX group;
   2> stop drx-InactivityTimer for each DRX group.
1> if drx-InactivityTimer for a DRX group expires:
   2> if the Short DRX cycle is configured:
      3> start or restart drx-ShortCycle Timer for this DRX group in the first symbol after the expiry of drx-InactivityTimer;
      3> use the Short DRX cycle for this DRX group.
   2> else:
      3> use the Long DRX cycle for this DRX group.
1> if a DRX Command MAC CE is received:
   2> if the Short DRX cycle is configured:
      3> start or restart drx-ShortCycle Timer for each DRX group in the first symbol after the end of DRX Command MAC CE reception;
      3> use the Short DRX cycle for each DRX group.
   2> else:
      3> use the Long DRX cycle for each DRX group.
1> if drx-ShortCycle Timer for a DRX group expires:
   2> use the Long DRX cycle for this DRX group.
1> if a Long DRX Command MAC CE is received:
   2> stop drx-ShortCycle Timer for each DRX group;
   2> use the Long DRX cycle for each DRX group.
1> if the Short DRX cycle is used for a DRX group, and [(system frame number (SFN)×10)+subframe number] modulo (drx-ShortCycle)=(drx-StartOffset) modulo (drx-ShortCycle):
   2> start drx-onDurationTimer for this DRX group after drx-SlotOffset from the beginning of the subframe.
1> if the Long DRX cycle is used for a DRX group, and [(SFN×10)+subframe number] modulo (drx-LongCycle)=drx-StartOffset:
   2> if DCP monitoring is configured for the active DL bandwidth part (BWP) as specified in TS 38.213 [6], clause 10.3:
      3> if DCP indication associated with the current DRX cycle received from lower layer indicated to start drx-onDurationTimer, as specified in TS 38.213 [6]; or
      3> if all DCP occasion(s) in time domain, as specified in TS 38.213 [6], associated with the current DRX cycle occurred in Active Time considering grants/assignments/DRX Command MAC CE/Long DRX Command MAC CE received and Scheduling Request sent until 4 ms prior to start of the last DCP occasion, or during a measurement gap, or when the MAC entity monitors for a PDCCH transmission on the search space indicated by recoverySearchSpaceId of the SpCell identified by the C-RNTI while the ra-Response Window is running (as specified in clause 5.1.4); or
      3> if ps-Wakeup is configured with value true and DCP indication associated with the current DRX cycle has not been received from lower layers:
         4> start drx-onDurationTimer after drx-SlotOffset from the beginning of the subframe.
   2> else:
      3> start drx-onDurationTimer for this DRX group after drx-SlotOffset from the beginning of the subframe.
NOTE 2: In case of unaligned SFN across carriers in a cell group, the SFN of the SpCell is used to calculate the DRX duration.
1> if a DRX group is in Active Time:
   2> monitor the PDCCH on the Serving Cells in this DRX group as specified in TS 38.213 [6];
   2> if the PDCCH indicates a DL transmission:
      3> start the drx-HARQ-RTT-TimerDL for the corresponding HARQ process in the first symbol after the end of the corresponding transmission carrying the DL HARQ feedback;
NOTE 3: When HARQ feedback is postponed by physical downlink shared channel (PDSCH)-to-HARQ_feedback timing indicating a non-numerical kl value, as specified in TS 38.213 [6], the corresponding transmission opportunity to send the DL HARQ feedback is indicated in a later PDCCH requesting the HARQ-ACK feedback.
   3> stop the drx-RetransmissionTimerDL for the corresponding HARQ process.
   3> if the PDSCH-to-HARQ_feedback timing indicate a non-numerical kl value as specified in TS 38.213 [6]:
      4> start the drx-RetransmissionTimerDL in the first symbol after the (end of the last) PDSCH transmission (within a bundle) for the corresponding HARQ process.
   2> if the PDCCH indicates a UL transmission:
      3> start the drx-HARQ-RTT-TimerUL for the corresponding HARQ process in the first symbol after the end of the first transmission (within a bundle) of the corresponding PUSCH transmission;
      3> stop the drx-Retransmission TimerUL for the corresponding HARQ process.
   2> if the PDCCH indicates a new transmission (DL or UL) on a Serving Cell in this DRX group:
      3> start or restart drx-InactivityTimer for this DRX group in the first symbol after the end of the PDCCH reception.
NOTE 3a: A PDCCH indicating activation of SPS or configured grant type 2 is considered to indicate a new transmission.
   2> if a HARQ process receives downlink feedback information and acknowledgement is indicated:
      3> stop the drx-RetransmissionTimerUL for the corresponding HARQ process.
1> if DCP monitoring is configured for the active DL BWP as specified in TS 38.213 [6], clause 10.3; and
1> if the current symbol n occurs within drx-onDurationTimer duration; and
1> if drx-onDurationTimer associated with the current DRX cycle is not started as specified in this clause:
   2> if the MAC entity would not be in Active Time considering grants/assignments/DRX Command MAC CE/Long DRX Command MAC CE received and Scheduling Request sent until 4 ms prior to symbol n when evaluating all DRX Active Time conditions as specified in this clause:
      3> not transmit periodic sounding reference signal (SRS) and semi-persistent SRS defined in TS 38.214 [7];
      3> not report semi-persistent CSI configured on PUSCH;
      3> if ps-TransmitPeriodicL1-RSRP is not configured with value true:
         4> not report periodic CSI that is L1-RSRP on PUCCH.
      3> if ps-TransmitOtherPeriodicCSI is not configured with value true:
         4> not report periodic CSI that is not L1-RSRP on PUCCH.
1> else:
   2> in current symbol n, if a DRX group would not be in Active Time considering grants/assignments scheduled on Serving Cell(s) in this DRX group and DRX Command MAC CE/Long DRX Command MAC CE received and Scheduling Request sent until 4 ms prior to symbol n when evaluating all DRX Active Time conditions as specified in this clause:
      3> not transmit periodic SRS and semi-persistent SRS defined in TS 38.214 [7] in this DRX group;
      3> not report CSI on PUCCH and semi-persistent CSI configured on PUSCH in this DRX group.
   2> if CSI masking (csi-Mask) is setup by upper layers:
      3> in current symbol n, if drx-onDurationTimer of a DRX group would not be running considering grants/assignments scheduled on Serving Cell(s) in this DRX group and DRX Command MAC CE/Long DRX Command MAC CE received until 4 ms prior to symbol n when evaluating all DRX Active Time conditions as specified in this clause; and
         4> not report CSI on PUCCH in this DRX group.
NOTE 4: If a UE multiplexes a CSI configured on PUCCH with other overlapping uplink control information (UCI(s)) according to the procedure specified in TS 38.213 [6] clause 9.2.5 and this CSI multiplexed with other UCI(s) would be reported on a PUCCH resource either outside DRX Active Time of the DRX group in which this PUCCH is configured or outside the on-duration period of the DRX group in which this PUCCH is configured if CSI masking is setup by upper layers, it is up to UE implementation whether to report this CSI multiplexed with other UCI(s).

In some current scenarios, regardless of whether the MAC entity is monitoring PDCCH or not on the Serving Cells in a DRX group, the MAC entity transmits HARQ feedback, aperiodic CSI on PUSCH, and aperiodic SRS defined in TS 38.214 [7] on the Serving Cells in the DRX group when such is expected. Further, the MAC entity may not need to monitor the PDCCH if it is not a complete PDCCH occasion, e.g. the Active Time starts or ends in the middle of a PDCCH occasion.

Many of the XR and cloud gaming use cases are characterised by quasi-periodic traffic (with possible jitter) with high data rate in DL (e.g., video steam) combined with the frequent UL (e.g., pose/control update) and/or UL video stream. Both DL and UL traffic are also characterized by relatively strict PDB.

For instance, the set of anticipated XR and Cloud Gaming services may have a certain variety and characteristics of the data streams (e.g., video) that may change “on-the-fly”, while the services are running wireless connectivity. Therefore, additional information on the running services from higher layers, e.g., the QoS flow association, frame-level QoS, ADU-based QoS, XR specific QoS etc, may be beneficial to facilitate informed choices of radio parameters. Further, XR application awareness by a UE and network entity may improve the user experience, improve the wireless system capacity in supporting XR services, and reduce the UE power consumption. As discussed herein, an ADU may refer to a smallest unit of data that can be processed independently by an application, such as processing for handling out-of-order traffic data.

The latency requirement of XR traffic in RAN side (e.g., air interface) can be modelled as PDB. The PDB is a limited time budget for a packet to be transmitted over the air from a network entity to a UE. For a given packet, the delay of the packet incurred in air interface can be measured from the time that the packet arrives at the network entity to the time that it is successfully transferred to the UE. If the delay is larger than a given PDB for the packet, then, the packet is said to violate PDB, otherwise the packet is said to be successfully delivered.

The value of PDB may vary for different applications and traffic types, which can be 10-20 ms depending on the application (see technical report (TR) 26.926).

According to R1-2112245: 5G arrival time of data bursts on the downlink can be quasi-periodic, e.g., periodic with jitter. Some of the factors leading to jitter in burst arrival include varying server render time, encoder time, real-time transport protocol (RTP) packetization time, link between server and 5G gateway etc. 3GPP agreed simulation assumptions for XR evaluation model DL traffic arrival jitter using truncated Gaussian distribution with mean: 0 ms, std. dev: 2 ms, range: [−4 ms, 4 ms] (baseline), [−5 ms, 5 ms] (optional).

Further, applications can have a certain delay requirement on an ADU, that may not be adequately translated into packet delay budget requirements. For example, if the ADU delay budget (ADB) is 10 ms, then PDB can be set to 10 ms only if all packets of the ADU arrive at the 5G system at the same time. If the packets are spread out, then ADU delay budget is measured either in terms of the arrival of the first packet of the ADU or the last packet of the ADU. In either case, a given ADB will result in different PDB requirements on different packets of the ADU.

Accordingly, solutions are provided in this disclosure to allow enhanced scheduling in a network entity in order to increase the resource efficiency as well as capacity, such as for XR traffic. Furthermore, enhancements in the UE for UL transmissions of XR traffic are provided.

In some scenarios DRX ActiveTimes of the different DRX configurations may overlap and the DRX timer values of the different DRX configurations are different. Hence it would be helpful for the UE to know, when a PDCCH is received within some “overlapping” ActiveTime, which DRX timer to update in response to the reception of the timer.

Accordingly, in implementations a DCI allocating downlink and/or uplink resources includes a field which identifies a DRX configuration. For scenarios where UE is configured with multiple DRX configurations and more than one DRX configurations are active (e.g., currently applied by the UE respectively the MAC entity in the UE), the DCI can identify by means of an indication for which DRX configuration a resource allocation applies to. This can be important for cases when the ActiveTimes of the different DRX configurations overlap in time. For instance, when a UE is starting DRX related timers in response to receiving a PDCCH and or PDSCH/PUSCH, it would be helpful for the UE to know for which of the multiple DRX configurations to (re) start or stop or to update the corresponding timer.

In some scenarios timer values can be different for different DRX configurations. Therefore, in at least one implementation the DCI includes a field which conveys an identifier identifying the DRX configuration a PDCCH and/or PDSCH/PUSCH transmission is associated with. This signalling, for instance, ensures that a UE and network entity are synchronized and aligned regarding a DRX behaviour and/or DRXstate.

According to at least one implementation, a UE is configured and/or assigned a different Radio Network Temporary Identifier (RNTI) for each of the multiple DRX configurations. For instance, when scheduling DL/UL resources a network entity uses the corresponding RNTI for the PDCCH in order to indicate to the UE the DRX configuration to which this resource allocation is associated with. Based on the received RNTI, the UE and/or MAC knows for which of the multiple DRX configurations it is to (re) start and/or stop the corresponding DRX-related timer(s).

In at least some implementations, a UE starts/updates corresponding DRX-related timer(s) for each of the DRX configurations where an ActiveTime is overlapping in response to receiving a resource allocation, e.g., PDCCH. For instance, the UE can start DRX timers of multiple DRX configurations which may cause the ActiveTime to be extended according to the timer with the largest value. A benefit of this implementation may be that no additional signalling is required in order to identify the DRX configuration.

In at least some implementations, a network entity configures a separate search space and/or CORESET for each of the multiple DRX configurations. For instance, based on the search space and/or CORESET a PDCCH was received on, a UE can identify and determine for which of the multiple DRX configurations to perform corresponding DRX-related timer updates.

In at least some implementations, a UE determines based on a predefined rule for which of the multiple DRX configurations to update corresponding DRX-related timers. The rule, for example, specifies that the UE updates the DRX-related timers of the DRX configuration with the smallest timer values or the largest timer values. For instance, upon reception of a PDCCH allocating DL/UL resources for an initial transmission, the UE starts the drx-inactivitytimer of the multiple overlapping DRX configurations which has the smallest timer value or the largest timer value, depending on the implementation of the rule.

Accordingly, implementations discussed above include aspects pertaining to scenarios where DRX ActiveTimes of different DRX configurations may overlap and where DRX timer values of different DRX configurations are different. A UE, for instance, is to know, when a PDCCH is received within an overlapping ActiveTime, which DRX timer to start in response to the reception of the timer. Aspects of the discussed implementations include:
PDCCH indicates the DRX config identifier (ID).
Different PDCCH search space for different DRX configurations.
Different RNTI.
For scenarios where DRX configurations overlap, s rule is provided which specifies which DRX timer is used, e.g., a timer with smallest length or a longest length.
In scenarios where LCHs are mapped to a DRX configuration: A UE can (e.g., in postprocessing) after decoding a packet, start a corresponding timer.
Start and/or restart of timers, e.g., for each DRX configuration start the corresponding timer(s).

According to further implementations, UE power consumption can be optimized by controlling transmission of SR, e.g., for alignment of DL/UL. For instance, configurations are provided to enable a UE to delay sending SR in order to avoid extending the ActiveTime. A network entity, for example, configures a max time to wait until sending a SR (e.g., network response time) for a logical channel (LCH) and UE can, based on this information, optimize the sending of SR, such as to delay SR transmission.

In one or more implementations, a LCH is configured with a parameter indicating whether a UE and/or MAC is to delay the transmission of an SR. For instance, a parameter is defined that is a Boolean which indicates whether a UE is to additionally delay the transmission of a SR (e.g., on PUCCH) upon being triggered or whether a UE is to perform the SR procedure as specified in the current specification, e.g., legacy behaviour.

Further to one or more implementations, a UE and/or MAC is configured with a time value which is used in the MAC in order to determine when to send the delayed SR transmission. For instance, the configured time value indicates a network response time, e.g., time from sending and/or receiving an SR to the transmission of the corresponding UL transmission.

According to one or more implementations, upon having triggered an SR in a UE and/or MAC, a UE starts in at least one example a timer for scenarios when the UE is configured to delay an SR transmission. For instance, the UE is to send the SR as long as the timer is running, e.g., before expiry of the timer. The timer, for example, denotes a time window during which the UE is to send the SR. The time window (e.g., timer value) is determined based on a packet delay budget of a transport block (TB) and the configured time value, e.g., network response.

In at least one example the timer value is set to the “PDB of the TB—the configured network response time.” In order to optimize the UE power consumption, a UE can be instructed to send the SR while the timer is running and the UE is in DRX ActiveTime. Further, in order to minimize the UE power consumption, the UE can send an SR while it is in DRX ActiveTime and monitoring PDCCH.

In some systems, a UE upon having sent a SR on PUCCH goes to ActiveTime and monitors PDCCH, e.g., for UL grants. Hence when the SR transmission falls within UE's ActiveTime no additional power consumption caused by PDCCH monitoring may be introduced. Further, a timer which is started upon SR triggering ensures that the UE doesn't send the SR too late to transmit a TB within the configured PDB. Further, when a UE is determining when to send the SR, the UE may consider the SR configuration, e.g., PUCCH resources allocated for transmission of SR.

According to an alternative or additional implementation, an LCH is configured with a time value which is used in the MAC in order to determine when to send a delayed SR transmission, e.g., a time value indicating the network response time.

Accordingly, implementations discussed above include aspects pertaining to whether a UE is to wait before sending SR, such as to avoid additionally extending the ActiveTime. A network entity, for instance, configures a max time to wait until sending SR (e.g., network response time) for a LCH and a UE can, based on this, optimize sending SR, e.g., delay SR transmission. Aspects of the discussed implementations include:
A network entity configures a time for a network response to an SR and a UE is to send the SR before RDB in the signaled time for network reaction, e.g., different than a SRdelayTimer.
UE behavior: send triggered SR when UE is in ActiveTime and timer is still running; when timer expires UE is to send SR regardless of DRX state.
UE is to consider SR resources (e.g., timing) when calculating a latest time when UE sends SR.

According to further implementations, configuration is provided for adaptation of DRX timers, e.g., dynamically controlling whether to update DRX timers. For instance, in at least some implementations a DCI indicates whether a UE is to start a drx-InactivityTimer in response to the reception of PDCCH carrying DCI. The DCI, for example, allocates either DL or UL resources for an initial transmission. In at least one example, information on whether to start the drx-InactivityTimer is signalled within a one-bit field in the DCI. For example, in case of the transmission of a last DL packet of a PDU set, it may not be beneficial to start the drx-InactivityTimer and extend the ActiveTime for scenarios where a network entity doesn't have further DL data for transmission. Therefore, allowing the network entity to dynamically control by means of DCI whether to start the drx-InactivityTimer in the UE in response to the reception of the DCI may improve (e.g., reduce) power consumption of the UE.

In at least some implementations, a DCI indicates whether a UE is to trigger the (re) starting of a DRX-related timer in response to the reception of the PDCCH and corresponding reception and/or transmission of PDSCH and/or PUSCH. The DCI, for instance, allocates DL and/or UL resources for a transmission. In at least one example the DRX-related timers comprise drx-InactivityTimer, drx-HARQ-RTT-TimerUL, drx-Retransmission TimerDL, drx-HARQ-RTT-TimerDL, and/or drx-Retransmission TimerUL. According to at least one implementation, the information on whether to start a DRX-related timer in response to the reception of the DCI and/or corresponding PDSCH or PUSCH is signalled within a one-bit field in the DCI. A UE, for instance, is not to start the drx-InactivityTimer in response to the reception of a DCI indicating not to start any DRX-related timers. Further, the UE is not to start the drx-HARQ-RTT-TimerDL and the drx-Retransmission TimerDL in response to the reception of a corresponding PDSCH. In scenarios where a UE does not decode the PDSCH correctly, the UE is not to start the drx-RetransmissionTimerDL and monitor PDCCH for retransmissions according to one or more implementations. Further, the UE is not to start the drx-HARQ-RTT-TimerUL and subsequently the drx-RetransmissionTimerUL upon transmission of the PUSCH scheduled by the DCI.

According to one or more implementations, a DCI scheduling an initial transmission indicates whether a UE is to start the drx-HARQ-RTT-TimerDL in response to the reception of the PDCCH and/or PDSCH. In at least one example the DCI further indicates whether a UE is to transmit a HARQ feedback (e.g., acknowledgement (ACK) or negative ACK (NACK)) in response to the reception of the PDSCH and start the drx-Retransmission TimerDL in response to the transmission of a NACK. For scenarios where a DL transmission has a tight latency budget which doesn't allow for a HARQ retransmission, a UE doesn't need to monitor PDCCH for potential retransmissions, e.g., starting the drx-RetransmissionTimerDL timer as well as skipping the transmission of the ACK/NACK. In at least one example, information indicating that the UE is not to start the drx-HARQ-RTT-TimerDL and/or is not to transmit a HARQ feedback (e.g., ACK and/or NACK) in response to the reception of the PDSCH and is not start the drx-Retransmission TimerDL is signalled within a field in the DCI. In alternative or additional implementations, this information is signalled by reusing an existing field in DCI. In at least one example, a specific K1 value “PDSCH-to-HARQ-timing-indicator” indicating the transmission timing of the HARQ feedback indicates that a UE is not to start the HARQ-RTT-TimerDL, drx-Retransmission TimerDL, timer and/or that UE is not to transmit the HARQ ACK/NACK.

According to one or more implementations, a DCI indicates to a UE not to start the drx-HARQ-RTT-TimerDL timer in response to PDCCH and/or PDSCH reception. In at least one example the indication is signalled by means of the “PDSCH-to-HARQ-timing-indicator” field, e.g., K1 value. In at least one example, for scenarios where the signalled K1 value is larger than a predefined threshold and/or if the signalled K1 value is larger than a remaining delay budget of the data (e.g., as indicated within the DCI), a UE is not to start the drx-HARQ-RTT-TimerDL timer and is not start the drx-Retransmission TimerDL timer. For instance, the UE is not to extend ActiveTime and monitor PDCCH for retransmissions.

According to one or more implementations, a downlink HARQ process is configured with a configuration indicating whether a UE is to start the drx-HARQ-RTT-TimerDL timer in response to a PDCCH and/or PDSCH received on that HARQ process. In at least one example, the configuration defines whether the UE is to send a HARQ feedback for a corresponding PDSCH transmission. For instance, two different configurations of DL HARQ processes are defined. Further, HARQ processes according to a first configuration can behave as in previous implementations regarding DRX timer handling and/or HARQ feedback transmission. A DL HARQ process configured according to a second configuration can provide a different DRX timer handling for DL transmissions occurring on the HARQ process compared to previous implementations for DRX behaviour.

In at least one example a DL HARQ process configured according to the second configuration is used for low-latency transmissions that may not tolerate HARQ retransmissions. For instance, PDCCH and/or PDSCH transmissions occurring on a HARQ process configured according to the second configuration may not trigger the start of the drx-HARQ-RTT-TimerDL timer and drx-Retransmission TimerDL timer. In at least one example a UE may also not send a HARQ feedback in response to the reception of a PDSCH transmission on a HARQ process configured according to the second configuration.

In one or more implementations, a UE ignores the “PDSCH-to-HARQ-timing-indicator” field (e.g., K1 timing) in a DCI for a HARQ process indicated by a HARQ process ID field that does not support HARQ retransmissions and HARQ feedback signalling, e.g., a HARQ process configured according to the second configuration. For instance, the “PDSCH-to-HARQ-timing-indicator” field used for a K1 value can be repurposed for scenarios where a HARQ process ID indicates a HARQ process that does not support HARQ retransmission and/or HARQ feedback transmission.

In one or more implementations, an UL HARQ process is configured with a configuration indicating whether a UE is to start the drx-HARQ-RTT-TimerUL timer in response to a PUSCH transmitted on the HARQ process.

In at least one example, a HARQ process configuration defines whether a UE monitors PDCCH for retransmission grants and/or whether the UE is to perform HARQ retransmissions on PUSCH. In at least one example two different configurations of UL HARQ processes are specified. For instance, HARQ processes according to a first configuration behave as in previous implementations regarding DRX timer handling and/or HARQ retransmissions. An UL HARQ process configured according to the second configuration provides a different DRX behavior for UL transmissions occurring on the HARQ process compared to previous implementations for DRX behaviour.

In at least one example, an UL HARQ process configured according to the second configuration is used for low-latency transmissions that may not tolerate HARQ retransmissions. PUSCH transmissions occurring on a HARQ process configured according to the second configuration, for instance, may not trigger the start of the drx-HARQ-RTT-TimerUL, timer and drx-RetransmissionTimerUL timer. In at least one example, a UE is not to perform a HARQ retransmission on PUSCH in response to the reception of a PDCCH scheduling a HARQ retransmission on a HARQ process configured according to the second configuration, e.g., the UE ignores DCI scheduling a retransmission.

According to one or more implementations, an uplink CG configuration includes an IE indicating whether UL transmissions on the CG resources trigger the starting of the drx-HARQ-RTT-TimerUL timer and the drx-Retransmission TimerUL timer. For instance, for CG configurations used for XR traffic with tight latency requirements (e.g., for CG configurations that may not tolerate HARQ retransmissions), a UE is not to monitor PDCCH for retransmission grants, e.g., DCI with CS-RNTI. Thus, a UE according to this implementation, is not to extend the ActiveTime by starting the drx-HARQ-RTT-TimerUL timer and consequently the drx-Retransmission TimerUL timer. In at least one example, the UE ignores a PDCCH scheduling a HARQ retransmission for a previous PUSCH transmission which was performed on CG PUSCH resources configured with the IE, e.g., where the IE indicates that retransmissions are not supported.

According to one or more implementations, an UL CG configuration includes an IE configuring the drx-HARQ-RTT-TimerUL timer value and/or drx-Retransmission TimerUL timer value to be applied for UL transmissions performed on the corresponding uplink CG resources. For instance, when a UE performs a PUSCH transmission on CG PUSCH resources of the CG configuration, the UE starts the drx-HARQ-RTT-TimerUL timer set to a value configured in the UL CG configuration IE. Further, the UE starts the drx-RetransmissionTimerUL timer set to the configured value. In at least one example, a drx-HARQ-RTT-TimerUL timer value configured to zero indicates that the UE is not to start the drx-HARQ-RTT-TimerUL timer and the drx-Retransmission TimerUL timer in response to having performed an UL transmission on a CG PUSCH resource of the UL CG configuration.

According to one or more implementations, CG configurations for UL transmissions are configured specifically for XR data/traffic. For instance, an IE (e.g., ConfiguredGrantConfig-XR as described below) is provided which configures semi-persistent UL resources (e.g., CG-PUSCH resources) for XR traffic. In at least some implementations, some of the IE parameters of this CG configuration are similar to previous CG configurations. In at least one example, new parameters and/or IEs are included in the XR-specific CG configuration which are XR specific such as discussed above, e.g., drx-HARQ-RTT-TimerUL timer value, drx-Retransmission TimerUL, timer value, indication of whether HARQ retransmissions are supported, etc.

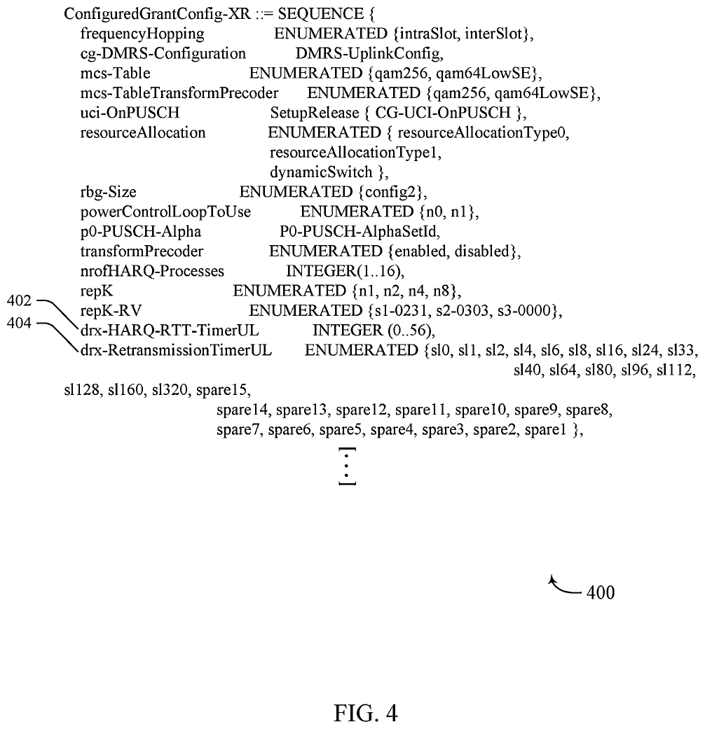

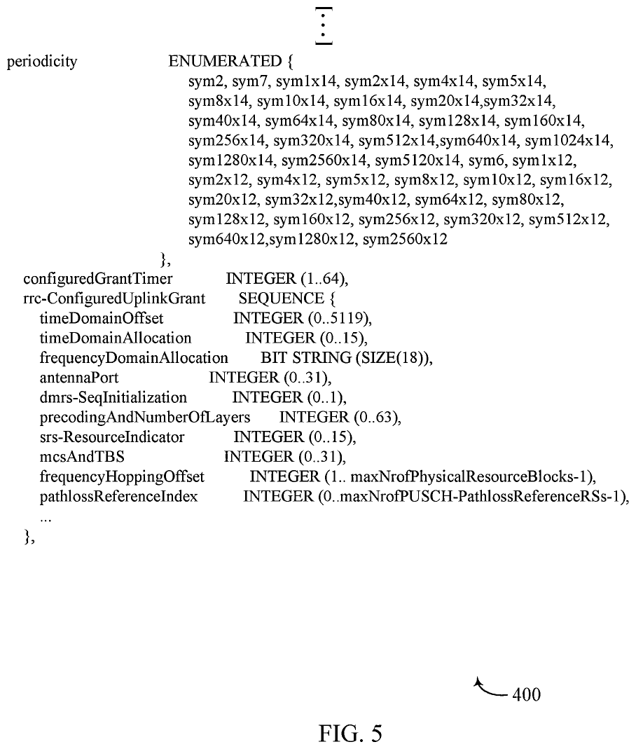

FIGS. 4 and 5 illustrate different respective portions of an IE 400 that supports timing control in wireless communications in accordance with aspects of the present disclosure. The IE 400 (e.g., “ConfiguredGrantConfig-XR”), for instance, supports CG configuration for XR. The IE 400 includes a parameter 402 and a parameter 404 that specify configurations (e.g., values) for different timers. The parameter 402, for instance, specifies configuration (e.g., values) for a HARQ RTT timer (e.g., drx-HARQ-RTT-TimerUL), and the parameter 404 specifies configuration (e.g., values) for an UL retransmission timer, e.g., drx-RetransmissionTimerUL. FIG. 5 illustrates further features and parameters of the IE 400. In at least some implementations the portions of the IE 400 in FIGS. 4 and 5 can be combined into a single IE. Alternatively or additionally, portions of the IE 400 can be communicated via different IEs and/or notifications.

According to one or more implementations, a UE is not to start the drx-HARQ-RTT-TimerUL timer and the drx-RetransmissionTimerUL timer for scenarios where a configured latency bound (e.g., delay budget) of a TB is smaller than a configured threshold. In at least one example, the UE determines the delay budget and/or packet delay budget of a TB as a smallest or largest delay budget associated with a LCH amongst the LCHs multiplexed in the TB. For instance, a network entity configures the threshold which is used to determine whether a UE extends the ActiveTime by starting the drx-HARQ-RTT-TimerUL timer and/or drx-RetransmissionTimerUL timer. In at least some implementations, for data with strict delay requirements (e.g., not allowing a HARQ retransmission), a UE is not to extend the ActiveTime and monitor PDCCH, e.g., for potential retransmission grants. A network entity, for instance, is aware of the delay budget of a PUSCH transmission and/or TB. This behavior can be ensured by controlling which LCHs are allowed to be mapped on scheduled UL resources, e.g., by means of LCH restrictions. For CG, for example, a network entity can control which LCHs are permitted to be mapped to the CG resources and thus the network entity is aware of the PDB.

According to one or more implementations, an LCH is configured with an LCH parameter (e.g., LCH field) indicating whether HARQ retransmissions are supported for PUSCH transmissions including data of the LCH. In at least one example the LCH parameter is signalled within the logicalchannelconfig IE. For example, for scenarios where a TB includes data of a LCH which is configured to not support HARQ retransmissions, a UE, in response to having performed the PUSCH transmission, is not to start the drx-HARQ-RTT-TimerUL timer and/or drx-RetransmissionTimerUL timer. The UE, for instance, does not extend the ActiveTime and monitor PDCCH for retransmission grants. In scenarios where the logicalchannelconfig IE does not contain the LCH parameter (e.g., the LCH parameter is not present in the logicalchannelconfig IE), and/or the LCH parameter indicates that HARQ retransmissions are supported for data transmissions of the LCH (e.g., the LCH parameter is a Boolean), a UE can apply previous DRX behaviour for PUSCH transmissions.

According to one or more implementations, a HARQ process is configured with a configuration indicating that a UE is not to start the drx-HARQ-RTT-TimerUL timer in response to a PUSCH transmitted on that HARQ process. In such implementations, a UE can consider, during a logical channel prioritization (LCP) procedure, only LCHs not supporting HARQ retransmissions for cases when a PUSCH transmission (initial transmission) is scheduled on such HARQ processes. In at least one example, LCHs are configured with a HARQ retransmission mode configuration by means of a field in the logicalchannelconfig IE as discussed above. According to at least one implementation, a UE multiplexes only data of LCHs in a TB which are configured with a same HARQ retransmission mode, e.g., a mode supporting HARQ retransmissions or a mode not supporting HARQ retransmissions. According to one or more implementations, an LCH mapping criterion (e.g., LCH to HARQ process mapping configuration) is provided. In at least one example the LCH mapping criterion specifies that, for scenarios where a PUSCH transmission is scheduled on a HARQ process which is configured with a DRX/HARQ mode supporting retransmissions, a UE considers only logical channels during the LCP procedure which are configured to support HARQ retransmissions. The UE, for instance, starts drx-HARQ-RTT-TimerUL timer in response to a PUSCH transmitted on such HARQ processes.

Accordingly, implementations discussed above include aspects pertaining to PDCCH retransmission timing. Aspects of the discussed implementations include:
Indicate in PDCCH for initial transmission whether NACK is to trigger a PDCCH retransmission timer, and/or whether to transmit NACK and/or also ACK. Implementations, for instance, indicate in DCI whether HARQ feedback is enabled or disabled.
   Last packet or latency bound doesn't permit HARQ retransmissions.
For UL, CG configuration can be configured for HARQ disable/enable operation.
   UE doesn't need to monitor for retransmission (e.g., CS-RNTI).
LCH configuration (e.g., HARQ disabled).
LCP rules for mux HARQ disable with HARQ enabled LCHs.
HARQ processes are configured whether with drxretransmissionTimer or not, and CGs are mapped to specific HARQ processes.
LCHs are configured to which HARQ processes they can be mapped.
HARQ RTT timer per-process (e.g., different values): HARQ_RTT timer value per CG configuration or DRX-retransmission timer, e.g., set to zero means no retransmission timer.
Example Rule: if PDB is below a threshold then UE is not to start HARQ RTT timer and Drx-Retx timer.
PUCCH format (e.g., ACK/NACK bundling).

Further, implementations discussed above include aspects pertaining to whether to start a DRX inactivity timer and/or timer values (e.g., list of configured values) for a last packet of a packet set (e.g., packet burst), such as where there is no time to start a DRX retransmission timer or DRX Inactivity timer. Aspects of the discussed implementations include:
PDCCH indicates “no DRX timer starting” (e.g., neither drx-inactivity nor drx-Retxtimer)
PDCCH indicates end of data burst
PDCCH indicates after a scheduled transmission, a UE is to transition to sleep mode, not start timers, etc.

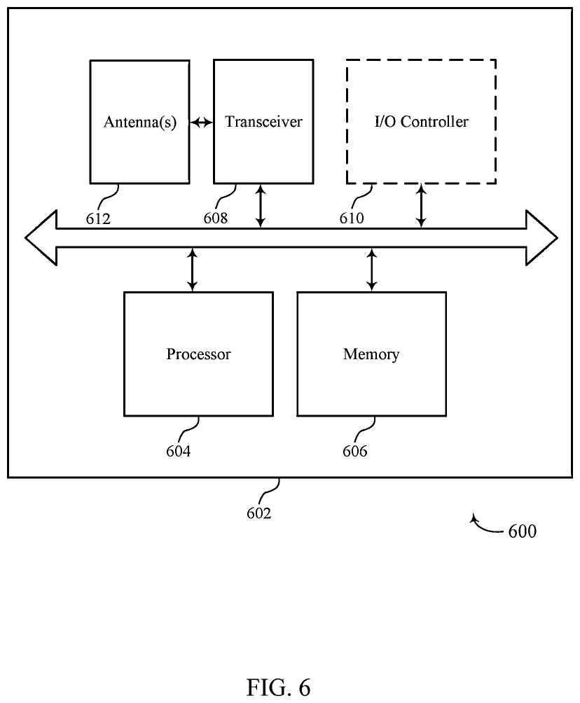

FIG. 6 illustrates an example of a block diagram 600 of a device 602 (e.g., an apparatus) that supports timing control in wireless communications in accordance with aspects of the present disclosure. The device 602 may be an example of UE 104 as described herein. The device 602 may support wireless communication with one or more network entities 102, UEs 104, or any combination thereof. The device 602 may include components for bi-directional communications including components for transmitting and receiving communications, such as a processor 604, a memory 606, a transceiver 608, and an I/O controller 610. These components may be in electronic communication or otherwise coupled (e.g., operatively, communicatively, functionally, electronically, electrically) via one or more interfaces (e.g., buses).

The processor 604, the memory 606, the transceiver 608, or various combinations thereof or various components thereof may be examples of means for performing various aspects of the present disclosure as described herein. For example, the processor 604, the memory 606, the transceiver 608, or various combinations or components thereof may support a method for performing one or more of the operations described herein.

In some implementations, the processor 604, the memory 606, the transceiver 608, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 604 and the memory 606 coupled with the processor 604 may be configured to perform one or more of the functions described herein (e.g., executing, by the processor 604, instructions stored in the memory 606). In the context of UE 104, for example, the transceiver 608 and the processor 604 coupled to the transceiver 608 are configured to cause the UE 104 to perform the various described operations and/or combinations thereof.

For example, the processor 604 and/or the transceiver 608 may support wireless communication at the device 602 in accordance with examples as disclosed herein. For instance, the processor 604 and/or the transceiver 608 may be configured as and/or otherwise support a means to receive, at a first time instance, DCI allocating a set of resources for a HARQ process, wherein the DCI includes a field indicating whether to start a timer; and start, at a second time instance, the timer based at least in part on the field indicating to start the timer.

Further, in some implementations, the DCI is allocating a set of downlink resources for a HARQ process; the second time instance is a first symbol after an end of a transmission carrying HARQ feedback for a downlink transmission allocated by the DCI; the timer is a drx-HARQ-RTT-TimerDL; the timer is a drx-HARQ-RTT-TimerUL; the timer is a drx-inactivityTimer; the second time instance is a first symbol after an end of reception of the DCI; the DCI further includes an indication of whether HARQ feedback is enabled or disabled; the DCI further includes an indication that if a PDB is below a threshold, the timer is not to be started; the DCI further includes an indication that after a transmission associated with the downlink resources, an apparatus is to transition to a sleep mode; the DCI further includes an indication of an end of a data burst after which the timer is not to be started.

In a further example, the processor 604 and/or the transceiver 608 may support wireless communication at the device 602 in accordance with examples as disclosed herein. The processor 604 and/or the transceiver 608, for instance, may be configured as or otherwise support a means to receive a notification identifying a wireless resource and a DRX configuration; select, based on the DRX configuration, a DRX timer from multiple different DRX timers; and configure the DRX timer.

Further, in some implementations, the notification includes a DRX configuration identifier; the notification is received as part of DCI; the notification includes multiple DRX configurations, and the processor and the transceiver are configured to cause the apparatus to start two or more of the multiple DRX timers that correspond to the multiple DRX configurations; the notification includes multiple DRX configurations and indicates one or more of a search space or a CORESET for each of the DRX configurations; the notification includes multiple DRX configurations, and the processor and the transceiver are configured to cause the apparatus to apply a predefined rule based on the multiple DRX configurations to determine which of the multiple DRX timers to start.

In a further example, the processor 604 and/or the transceiver 608 may support wireless communication at the device 602 in accordance with examples as disclosed herein. The processor 604 and/or the transceiver 608, for instance, may be configured as or otherwise support a means to receive a notification identifying a maximum delay time for sending a scheduling request; and transmit a scheduling request at a time instance determined based at least in part on the maximum delay time.

Further, in some implementations, the processor and the transceiver are configured to cause the apparatus to apply the maximum delay time to delay the scheduling request until the time instance; the maximum delay time is based at least in part on a remaining PDB; the processor and the transceiver are configured to: when an apparatus is in an active DRX state, transmit the scheduling request before expiry of a scheduling request timer configured based at least in part on the maximum delay time; and when an apparatus is in an inactive DRX state, transmit the scheduling request after expiry of the scheduling request timer.

In a further example, the processor 604 and/or the transceiver 608 may support wireless communication at the device 602 in accordance with examples as disclosed herein. The processor 604 and/or the transceiver 608, for instance, may be configured as or otherwise support a means to receive a notification including configuration information indicating whether to start one or more timers in response to a PUSCH transmitted on a HARQ process; and operate, based on the configuration information, the one or more timers in response to PUSCH transmitted on the HARQ process.

Further, in some implementations, the one or more timers include a drx-HARQ-RTT-TimerUL timer; the configuration information further specifies one or more of whether to monitor PDCCH for a retransmission grant, or to perform a HARQ transmission on PUSCH; the configuration information includes: a first HARQ process configuration for which the one or more timers are to be started in response to PUSCH transmitted on the HARQ process; and a second HARQ process configuration for which the one or more timers are not to be started in response to PUSCH transmitted on the HARQ process; to operate the one or more timers in response to PUSCH transmitted on the HARQ process, the processor and the transceiver are configured to cause an apparatus to: start the one or more timers based on the first HARQ process configuration; or not start the one or more timers based on the second HARQ process configuration.

In a further example, the processor 604 and/or the transceiver 608 may support wireless communication at the device 602 in accordance with examples as disclosed herein. The processor 604 and/or the transceiver 608, for instance, may be configured as or otherwise support a means to receive a notification including configuration information including an uplink CG and an indication of whether to start one or more timers in response to uplink transmission on the uplink CG; and operate, based on the configuration information, the one or more timers in response to an uplink transmission on the uplink CG.

Further, in some implementations, the one or more timers include one or more of a drx-HARQ-RTT-TimerUL timer or a drx-Retransmission TimerUL timer; the configuration information includes an indication that the one or more timers are not to be started in response to uplink transmission of a particular data type on the uplink CG; the configuration information includes one or more timer values to be applied to the one or more timers in response to the uplink transmission on the uplink CG; to operate the one or more timers in response to the uplink transmission on the uplink CG, the processor and the transceiver are configured to cause an apparatus to apply the one or more timer values to the one or more timers; the configuration information includes an uplink CG configuration for XR data transmission on the uplink CG; the processor and the transceiver are configured to cause an apparatus to: apply the uplink CG configuration for XR data transmission to the uplink CG; and transmit XR data on the uplink CG configured for XR data transmission.

In a further example, the processor 604 and/or the transceiver 608 may support wireless communication at the device 602 in accordance with examples as disclosed herein. The processor 604 and/or the transceiver 608, for instance, may be configured as or otherwise support a means to receive a notification including configuration information including an uplink configured grant (CG) configuration and an indication of whether to start one or more timers in response to an uplink transmission on physical uplink shared channel (PUSCH) resources of the uplink configured grant configuration; and operate, based on the configuration information, the one or more timers in response to an uplink transmission on the CG PUSCH resources.

Further, in some implementations, the one or more timers include one or more of a drx-HARQ-RTT-TimerUL timer or a drx-Retransmission TimerUL timer; the configuration information includes an indication that the one or more timers are not to be started in response to the uplink transmission on the CG PUSCH resources; the configuration information includes an indication that one or more timers are not be started in a first symbol after an end of the PUSCH transmission; the configuration information includes one or more timer values to be applied to the one or more timers in response to the uplink transmission on the CG PUSCH resources; to operate the one or more timers in response to the uplink transmission on the uplink CG, the processor is configured to cause the UE to apply the one or more timer values to the one or more timers; the configuration information includes an uplink CG configuration for extended reality (XR) data transmission; the processor is configured to cause the UE to: apply the uplink CG configuration for extended reality (XR) data transmission; and transmit XR data on the CG PUSCH resources of the uplink CG configuration configured for XR data transmission.

The processor 604 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 604 may be configured to operate a memory array using a memory controller. In some other implementations, a memory controller may be integrated into the processor 604. The processor 604 may be configured to execute computer-readable instructions stored in a memory (e.g., the memory 606) to cause the device 602 to perform various functions of the present disclosure.

The memory 606 may include random access memory (RAM) and read-only memory (ROM). The memory 606 may store computer-readable, computer-executable code including instructions that, when executed by the processor 604 cause the device 602 to perform various functions described herein. The code may be stored in a non-transitory computer-readable medium such as system memory or another type of memory. In some implementations, the code may not be directly executable by the processor 604 but may cause a computer (e.g., when compiled and executed) to perform functions described herein. In some implementations, the memory 606 may include, among other things, a basic I/O system (BIOS) which may control basic hardware or software operation such as the interaction with peripheral components or devices.

The I/O controller 610 may manage input and output signals for the device 602. The I/O controller 610 may also manage peripherals not integrated into the device 602. In some implementations, the I/O controller 610 may represent a physical connection or port to an external peripheral. In some implementations, the I/O controller 610 may utilize an operating system such as iOS®, ANDROID®, MS-DOS®, MS-WINDOWS®, OS/2®, UNIX®, LINUX®, or another known operating system. In some implementations, the I/O controller 610 may be implemented as part of a processor, such as the processor 604. In some implementations, a user may interact with the device 602 via the I/O controller 610 or via hardware components controlled by the I/O controller 610.

In some implementations, the device 602 may include a single antenna 612. However, in some other implementations, the device 602 may have more than one antenna 612 (e.g., multiple antennas), including multiple antenna panels or antenna arrays, which may be capable of concurrently transmitting or receiving multiple wireless transmissions. The transceiver 608 may communicate bi-directionally, via the one or more antennas 612, wired, or wireless links as described herein. For example, the transceiver 608 may represent a wireless transceiver and may communicate bi-directionally with another wireless transceiver. The transceiver 608 may also include a modem to modulate the packets, to provide the modulated packets to one or more antennas 612 for transmission, and to demodulate packets received from the one or more antennas 612.

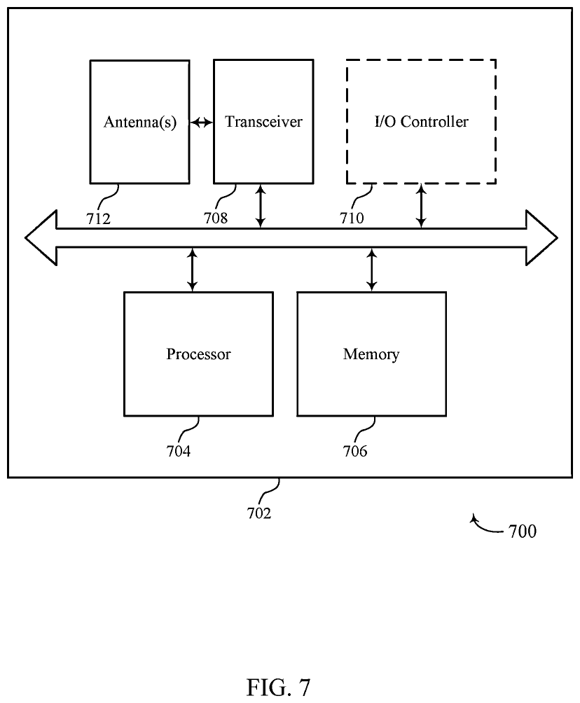

FIG. 7 illustrates an example of a block diagram 700 of a device 702 (e.g., an apparatus) that supports timing control in wireless communications in accordance with aspects of the present disclosure. The device 702 may be an example of a network entity 102 (e.g., a base station) as described herein. The device 702 may support wireless communication with one or more network entities 102, UEs 104, or any combination thereof. The device 702 may include components for bi-directional communications including components for transmitting and receiving communications, such as a processor 704, a memory 706, a transceiver 708, and an I/O controller 710. These components may be in electronic communication or otherwise coupled (e.g., operatively, communicatively, functionally, electronically, electrically) via one or more interfaces (e.g., buses).

The processor 704, the memory 706, the transceiver 708, or various combinations thereof or various components thereof may be examples of means for performing various aspects of the present disclosure as described herein. For example, the processor 704, the memory 706, the transceiver 708, or various combinations or components thereof may support a method for performing one or more of the operations described herein.

In some implementations, the processor 704, the memory 706, the transceiver 708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 704 and the memory 706 coupled with the processor 704 may be configured to perform one or more of the functions described herein (e.g., executing, by the processor 704, instructions stored in the memory 706). In the context of network entity 102, for example, the transceiver 708 and the processor 704 coupled to the transceiver 708 are configured to cause the network entity 102 to perform the various described operations and/or combinations thereof.

For example, the processor 704 and/or the transceiver 708 may support wireless communication at the device 702 in accordance with examples as disclosed herein. For instance, the processor 704 and/or the transceiver 708 may be configured as or otherwise support a means to generate DCI allocating a set of resources for a HARQ process, where the DCI includes a field indicating whether to start a timer; and transmit the DCI to a UE.

Further, in some implementations, the timer is a drx-HARQ-RTT-TimerDL; the timer is a drx-inactivity Timer; the DCI further includes an indication of whether HARQ feedback is enabled or disabled; the DCI further includes an indication that if a PDB is below a threshold, the timer is not to be started; the DCI further includes an indication that after a transmission associated with the downlink resources, an apparatus is to transition to a sleep mode; the DCI further includes an indication of an end of a data burst after which the timer is to be started.

In a further example, the processor 704 and/or the transceiver 708 may support wireless communication at the device 702 in accordance with examples as disclosed herein. The processor 704 and/or the transceiver 708, for instance, may be configured as or otherwise support a means to generate a notification identifying a wireless resource and a DRX configuration; and transmit the notification to a UE.

Further, in some implementations, the notification includes a DRX configuration identifier; the notification is transmitted as part of DCI; the notification includes multiple DRX configurations; the notification includes multiple DRX configurations and indicates one or more of a search space or a CORESET for each of the DRX configurations.

In a further example, the processor 704 and/or the transceiver 708 may support wireless communication at the device 702 in accordance with examples as disclosed herein. The processor 704 and/or the transceiver 708, for instance, may be configured as or otherwise support a means to generate a notification identifying a maximum delay time for sending a scheduling request; and transmit the notification to a UE.

Further, in some implementations, the maximum delay time is based at least in part on a remaining PDB; the notification further includes instructions indicating that: when the UE is in an active DRX state, to transmit the scheduling request before expiry of a scheduling request timer configured based at least in part on the maximum delay time; and when the UE is in an inactive DRX state, to transmit the scheduling request after expiry of the scheduling request timer.

In a further example, the processor 704 and/or the transceiver 708 may support wireless communication at the device 702 in accordance with examples as disclosed herein. The processor 704 and/or the transceiver 708, for instance, may be configured as or otherwise support a means to generate a notification including configuration information indicating whether to start one or more timers in response to a PUSCH transmitted on a HARQ process; and transmit the notification to a UE.

Further, in some implementations, the one or more timers include a drx-HARQ-RTT-TimerUL timer; the configuration information further specifies one or more of whether to monitor PDCCH for a retransmission grant, or to perform a HARQ transmission on PUSCH; the configuration information includes: a first HARQ process configuration for which the one or more timers are to be started in response to PUSCH transmitted on the HARQ process; and a second HARQ process configuration for which the one or more timers are not to be started in response to PUSCH transmitted on the HARQ process.

In a further example, the processor 704 and/or the transceiver 708 may support wireless communication at the device 702 in accordance with examples as disclosed herein. The processor 704 and/or the transceiver 708, for instance, may be configured as or otherwise support a means to generate a notification including configuration information including an uplink CG and an indication of whether to start one or more timers in response to uplink transmission on the uplink CG; and transmit the notification to a UE.

Further, in some implementations, the one or more timers include one or more of a drx-HARQ-RTT-TimerUL timer or a drx-Retransmission TimerUL timer; the configuration information includes an indication that the one or more timers are not to be started in response to uplink transmission of a particular data type on the uplink CG; the configuration information includes one or more timer values to be applied to the one or more timers in response to the uplink transmission on the uplink CG; the configuration information includes an uplink CG configuration for XR data transmission on the uplink CG.

In a further example, the processor 704 and/or the transceiver 708 may support wireless communication at the device 702 in accordance with examples as disclosed herein. The processor 704 and/or the transceiver 708, for instance, may be configured as or otherwise support a means to generate a notification including configuration information including an uplink configured grant (CG) configuration and an indication of whether to start one or more timers in response to an uplink transmission on physical uplink shared channel (PUSCH) resources of the uplink configured grant configuration; and transmit the notification to a UE; the one or more timers include one or more of a drx-HARQ-RTT-TimerUL timer or a drx-RetransmissionTimerUL timer; the configuration information includes an indication that the one or more timers are not to be started in response to the uplink transmission on the CG PUSCH resources; the configuration information includes an indication that one or more timers are not be started in a first symbol after an end of the PUSCH transmission; the configuration information includes an uplink CG configuration for extended reality (XR) data transmission.

The processor 704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 704 may be configured to operate a memory array using a memory controller. In some other implementations, a memory controller may be integrated into the processor 704. The processor 704 may be configured to execute computer-readable instructions stored in a memory (e.g., the memory 706) to cause the device 702 to perform various functions of the present disclosure.

The memory 706 may include random access memory (RAM) and read-only memory (ROM). The memory 706 may store computer-readable, computer-executable code including instructions that, when executed by the processor 704 cause the device 702 to perform various functions described herein. The code may be stored in a non-transitory computer-readable medium such as system memory or another type of memory. In some implementations, the code may not be directly executable by the processor 704 but may cause a computer (e.g., when compiled and executed) to perform functions described herein. In some implementations, the memory 706 may include, among other things, a basic I/O system (BIOS) which may control basic hardware or software operation such as the interaction with peripheral components or devices.

The I/O controller 710 may manage input and output signals for the device 702. The I/O controller 710 may also manage peripherals not integrated into the device 702. In some implementations, the I/O controller 710 may represent a physical connection or port to an external peripheral. In some implementations, the I/O controller 710 may utilize an operating system such as iOS®, ANDROID®, MS-DOS®, MS-WINDOWS®, OS/2®, UNIX®, LINUX®, or another known operating system. In some implementations, the I/O controller 710 may be implemented as part of a processor, such as the processor 704. In some implementations, a user may interact with the device 702 via the I/O controller 710 or via hardware components controlled by the I/O controller 710.

In some implementations, the device 702 may include a single antenna 712. However, in some other implementations, the device 702 may have more than one antenna 712 (e.g., multiple antennas), including multiple antenna panels or antenna arrays, which may be capable of concurrently transmitting or receiving multiple wireless transmissions. The transceiver 708 may communicate bi-directionally, via the one or more antennas 712, wired, or wireless links as described herein. For example, the transceiver 708 may represent a wireless transceiver and may communicate bi-directionally with another wireless transceiver. The transceiver 708 may also include a modem to modulate the packets, to provide the modulated packets to one or more antennas 712 for transmission, and to demodulate packets received from the one or more antennas 712.

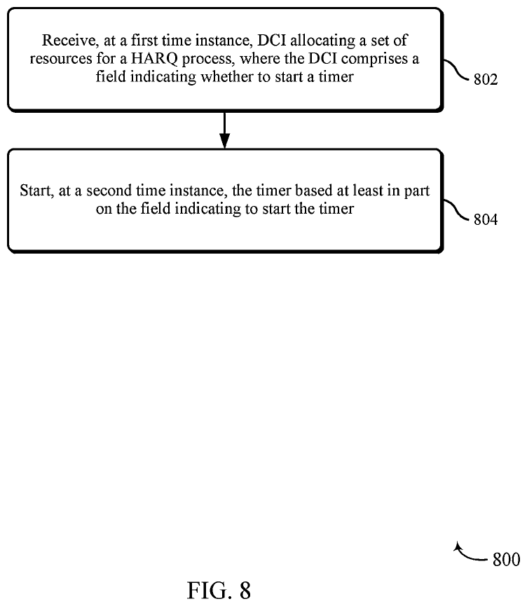

FIG. 8 illustrates a flowchart of a method 800 that supports timing control in wireless communications in accordance with aspects of the present disclosure. The operations of the method 800 may be implemented by a device or its components as described herein. For example, the operations of the method 800 may be performed by a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 802, the method may include receiving, at a first time instance, DCI allocating a set of resources for a HARQ process, where the DCI includes a field indicating whether to start a timer. The operations of 802 may be performed in accordance with examples as described herein. In some implementations, aspects of the operations of 802 may be performed by a device as described with reference to FIG. 1.

At 804, the method may include starting, at a second time instance, the timer based at least in part on the field indicating to start the timer. The operations of 804 may be performed in accordance with examples as described herein. In some implementations, aspects of the operations of 804 may be performed by a device as described with reference to FIG. 1.

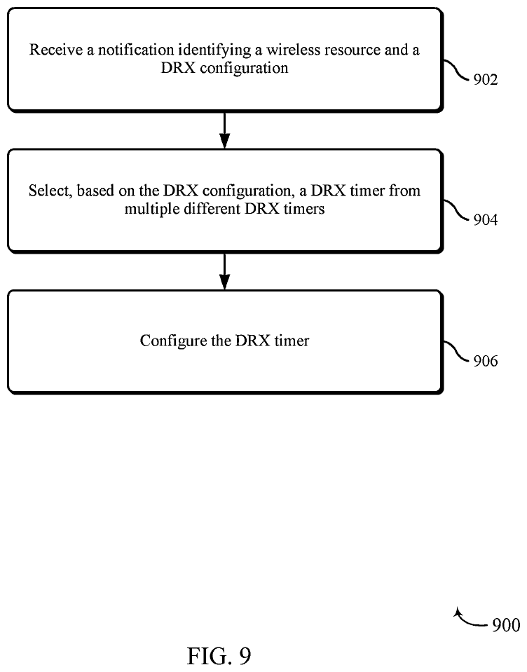

FIG. 9 illustrates a flowchart of a method 900 that supports timing control in wireless communications in accordance with aspects of the present disclosure. The operations of the method 900 may be implemented by a device or its components as described herein. For example, the operations of the method 900 may be performed by a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 902, the method may include receiving a notification identifying a wireless resource and a DRX configuration. The operations of 902 may be performed in accordance with examples as described herein. In some implementations, aspects of the operations of 902 may be performed by a device as described with reference to FIG. 1.

At 904, the method may include selecting, based on the DRX configuration, a DRX timer from multiple different DRX timers. The operations of 904 may be performed in accordance with examples as described herein. In some implementations, aspects of the operations of 904 may be performed by a device as described with reference to FIG. 1.

At 906, the method may include configuring the DRX timer. The operations of 906 may be performed in accordance with examples as described herein. In some implementations, aspects of the operations of 906 may be performed by a device as described with reference to FIG. 1.

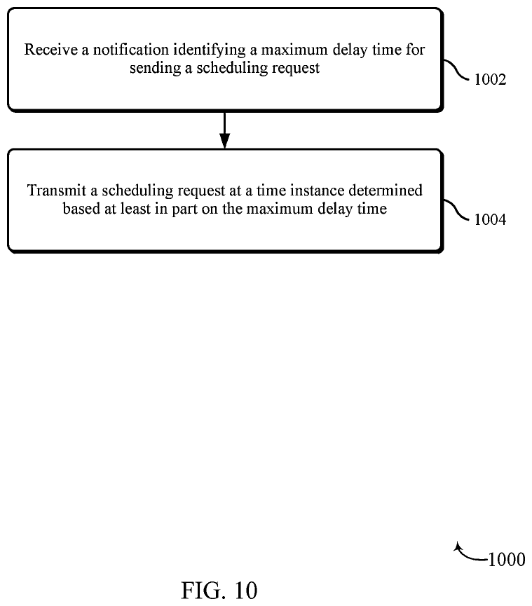

FIG. 10 illustrates a flowchart of a method 1000 that supports timing control in wireless communications in accordance with aspects of the present disclosure. The operations of the method 1000 may be implemented by a device or its components as described herein. For example, the operations of the method 1000 may be performed by a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1002, the method may include receiving a notification identifying a maximum delay time for sending a scheduling request. The operations of 1002 may be performed in accordance with examples as described herein. In some implementations, aspects of the operations of 1002 may be performed by a device as described with reference to FIG. 1.

At 1004, the method may include transmitting a scheduling request at a time instance determined based at least in part on the maximum delay time. The operations of 1004 may be performed in accordance with examples as described herein. In some implementations, aspects of the operations of 1004 may be performed by a device as described with reference to FIG. 1.

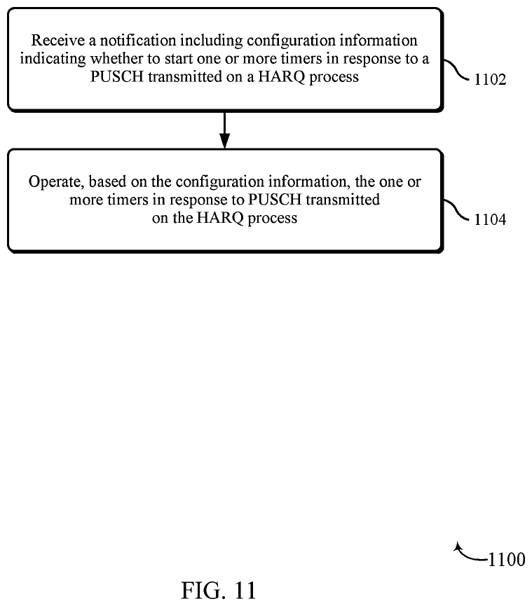

FIG. 11 illustrates a flowchart of a method 1100 that supports timing control in wireless communications in accordance with aspects of the present disclosure. The operations of the method 1100 may be implemented by a device or its components as described herein. For example, the operations of the method 1100 may be performed by a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1102, the method may include receiving a notification including configuration information indicating whether to start one or more timers in response to a PUSCH transmitted on a HARQ process. The operations of 1102 may be performed in accordance with examples as described herein. In some implementations, aspects of the operations of 1102 may be performed by a device as described with reference to FIG. 1.

At 1104, the method may include operating, based on the configuration information, the one or more timers in response to PUSCH transmitted on the HARQ process. The operations of 1104 may be performed in accordance with examples as described herein. In some implementations, aspects of the operations of 1104 may be performed by a device as described with reference to FIG. 1.

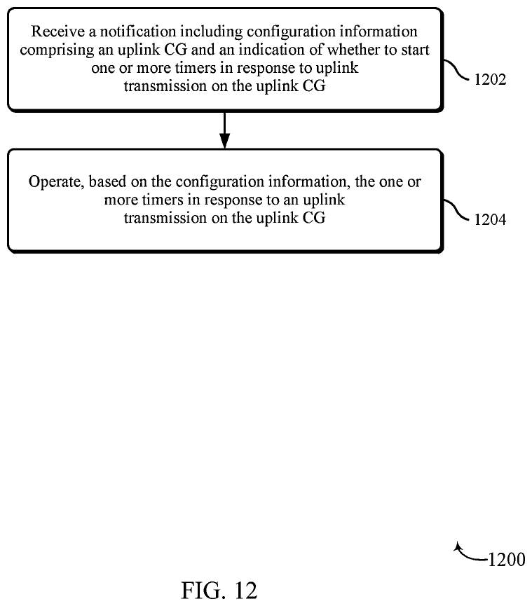

FIG. 12 illustrates a flowchart of a method 1200 that supports timing control in wireless communications in accordance with aspects of the present disclosure. The operations of the method 1200 may be implemented by a device or its components as described herein. For example, the operations of the method 1200 may be performed by a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1202, the method may include receiving a notification including configuration information comprising an uplink CG and an indication of whether to start one or more timers in response to uplink transmission on the uplink CG. The operations of 1202 may be performed in accordance with examples as described herein. In some implementations, aspects of the operations of 1202 may be performed by a device as described with reference to FIG. 1.

At 1204, the method may include operating, based on the configuration information, the one or more timers in response to an uplink transmission on the uplink CG. The operations of 1204 may be performed in accordance with examples as described herein. In some implementations, aspects of the operations of 1204 may be performed by a device as described with reference to FIG. 1.

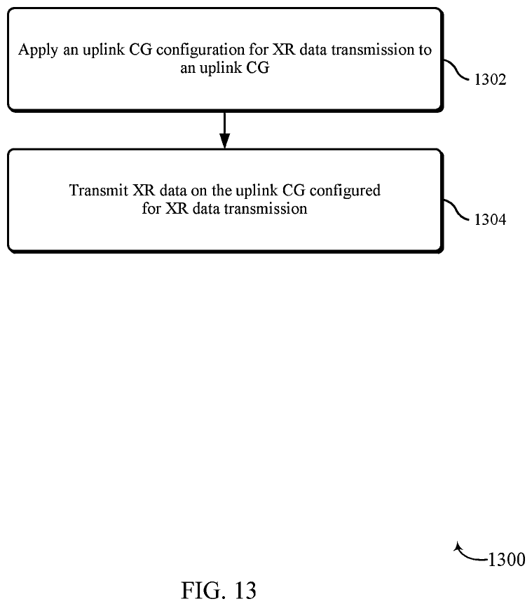

FIG. 13 illustrates a flowchart of a method 1300 that supports timing control in wireless communications in accordance with aspects of the present disclosure. The operations of the method 1300 may be implemented by a device or its components as described herein. For example, the operations of the method 1300 may be performed by a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1302, the method may include applying an uplink CG configuration for XR data transmission to an uplink CG. The operations of 1302 may be performed in accordance with examples as described herein. In some implementations, aspects of the operations of 1302 may be performed by a device as described with reference to FIG. 1.

At 1304, the method may include transmitting XR data on the uplink CG configured for XR data transmission. The operations of 1304 may be performed in accordance with examples as described herein. In some implementations, aspects of the operations of 1304 may be performed by a device as described with reference to FIG. 1.

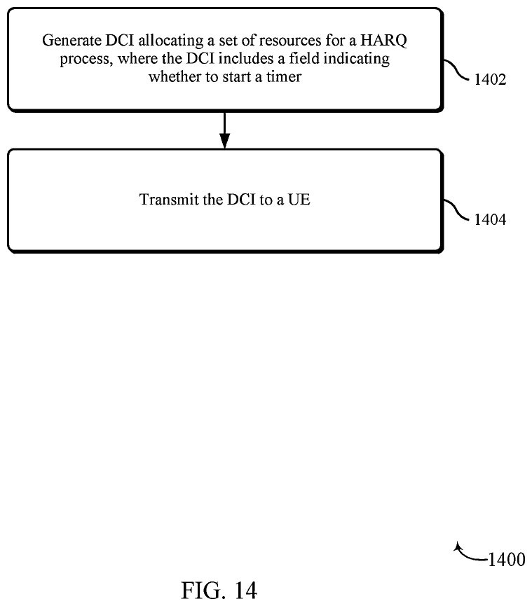

FIG. 14 illustrates a flowchart of a method 1400 that supports timing control in wireless communications in accordance with aspects of the present disclosure. The operations of the method 1400 may be implemented by a device or its components as described herein. For example, the operations of the method 1400 may be performed by a network entity 102 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1402, the method may include generating DCI allocating a set of resources for a HARQ process, where the DCI includes a field indicating whether to start a timer. The operations of 1402 may be performed in accordance with examples as described herein. In some implementations, aspects of the operations of 1402 may be performed by a device as described with reference to FIG. 1.

At 1404, the method may include transmitting the DCI to a UE. The operations of 1404 may be performed in accordance with examples as described herein. In some implementations, aspects of the operations of 1404 may be performed by a device as described with reference to FIG. 1.

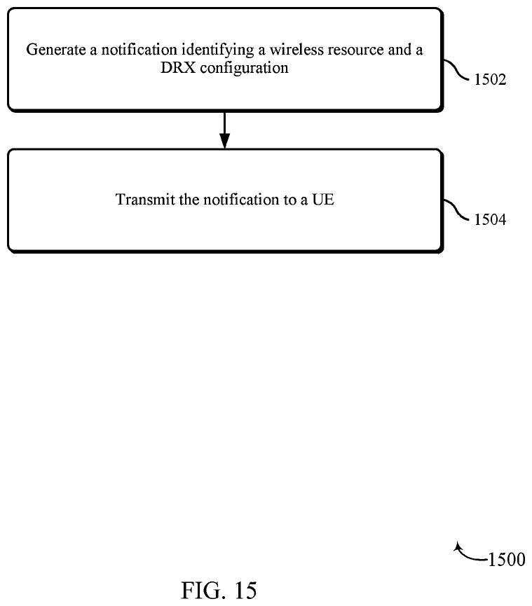

FIG. 15 illustrates a flowchart of a method 1500 that supports timing control in wireless communications in accordance with aspects of the present disclosure. The operations of the method 1500 may be implemented by a device or its components as described herein. For example, the operations of the method 1500 may be performed by a network entity 102 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1502, the method may include generating a notification identifying a wireless resource and a DRX configuration. The operations of 1502 may be performed in accordance with examples as described herein. In some implementations, aspects of the operations of 1502 may be performed by a device as described with reference to FIG. 1.

At 1504, the method may include transmitting the notification to a UE. The operations of 1504 may be performed in accordance with examples as described herein. In some implementations, aspects of the operations of 1504 may be performed by a device as described with reference to FIG. 1.

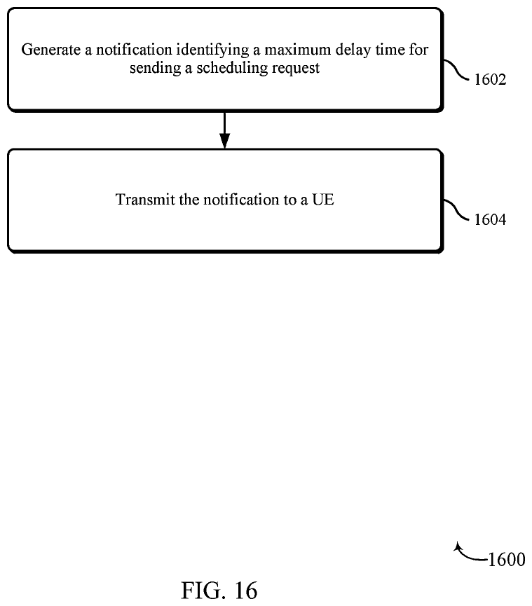

FIG. 16 illustrates a flowchart of a method 1600 that supports timing control in wireless communications in accordance with aspects of the present disclosure. The operations of the method 1600 may be implemented by a device or its components as described herein. For example, the operations of the method 1600 may be performed by a network entity 102 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1602, the method may include generating a notification identifying a maximum delay time for sending a scheduling request. The operations of 1602 may be performed in accordance with examples as described herein. In some implementations, aspects of the operations of 1602 may be performed by a device as described with reference to FIG. 1.

At 1604, the method may include transmitting the notification to a UE. The operations of 1604 may be performed in accordance with examples as described herein. In some implementations, aspects of the operations of 1604 may be performed by a device as described with reference to FIG. 1.

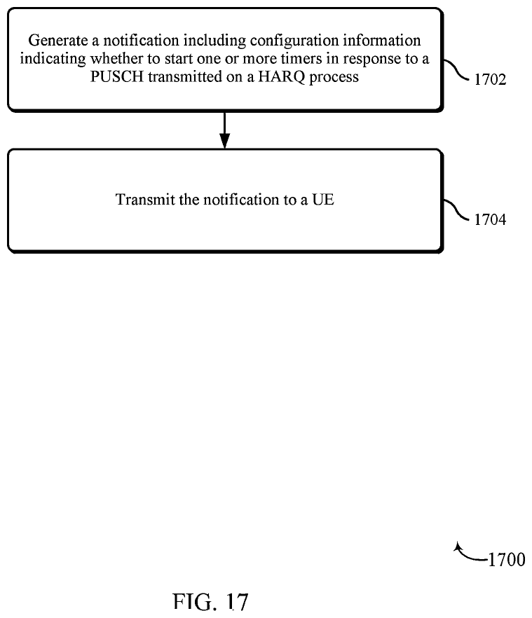

FIG. 17 illustrates a flowchart of a method 1700 that supports timing control in wireless communications in accordance with aspects of the present disclosure. The operations of the method 1700 may be implemented by a device or its components as described herein. For example, the operations of the method 1700 may be performed by a network entity 102 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1702, the method may include generating a notification including configuration information indicating whether to start one or more timers in response to a PUSCH transmitted on a HARQ process. The operations of 1702 may be performed in accordance with examples as described herein. In some implementations, aspects of the operations of 1702 may be performed by a device as described with reference to FIG. 1.

At 1704, the method may include transmitting the notification to a UE. The operations of 1704 may be performed in accordance with examples as described herein. In some implementations, aspects of the operations of 1704 may be performed by a device as described with reference to FIG. 1.

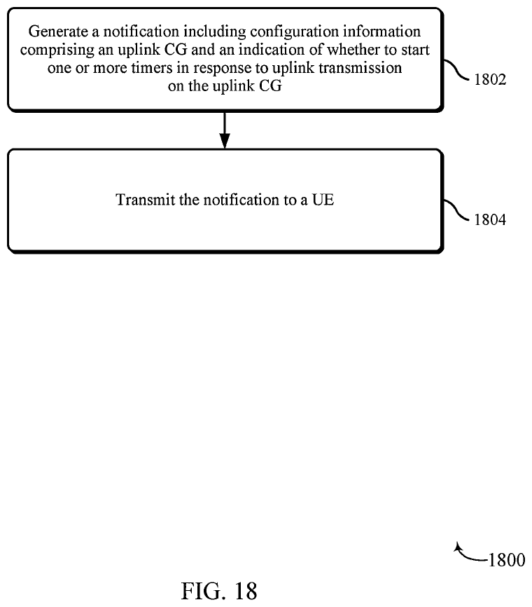

FIG. 18 illustrates a flowchart of a method 1800 that supports timing control in wireless communications in accordance with aspects of the present disclosure. The operations of the method 1800 may be implemented by a device or its components as described herein. For example, the operations of the method 1800 may be performed by a network entity 102 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1802, the method may include generating a notification including configuration information comprising an uplink CG and an indication of whether to start one or more timers in response to uplink transmission on the uplink CG. The operations of 1802 may be performed in accordance with examples as described herein. In some implementations, aspects of the operations of 1802 may be performed by a device as described with reference to FIG. 1.

At 1804, the method may include transmitting the notification to a UE. The operations of 1804 may be performed in accordance with examples as described herein. In some implementations, aspects of the operations of 1804 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.)

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a notification including configuration information comprising an uplink configured grant (CG) configuration and an indication of whether to start one or more timers in response to an uplink transmission on physical uplink shared channel (PUSCH) resources of the uplink CG configuration.

2. The UE of claim 1, wherein the one or more timers comprise a drx-HARQ-RTT-TimerUL timer.

3. The UE of claim 1, wherein the configuration information comprises an indication that the one or more timers are not to be started in response to the uplink transmission on the CG PUSCH resources.

4. The UE of claim 3, wherein the configuration information comprises an indication that one or more timers are not be started in a first symbol after an end of a PUSCH transmission.

5. The UE of claim 1, wherein the configuration information comprises one or more timer values to be applied to the one or more timers in response to the uplink transmission on the CG PUSCH resources.

6. The UE of claim 5, wherein to operate the one or more timers in response to the uplink transmission on the uplink CG, the processor is configured to cause the UE to apply the one or more timer values to the one or more timers.

7. The UE of claim 1, wherein the configuration information comprises an uplink CG configuration for extended reality (XR) data transmission.

8. (canceled)

9. A base station for wireless communication, comprising:
at least one memory; and
at least one processor coupled with the at least one memory and configured to cause the base station to:
generate a notification including configuration information comprising an uplink configured grant (CG) configuration and an indication of whether to start one or more timers in response to an uplink transmission on physical uplink shared channel (PUSCH) resources of the uplink CG configuration; and
transmit the notification to a user equipment (UE).

10. The base station of claim 9, wherein the one or more timers comprise a drx-HARQ-RTT-TimerUL timer.

11. The base station of claim 9, wherein the configuration information comprises an indication that the one or more timers are not to be started in response to the uplink transmission on the CG PUSCH resources.

12. The base station of claim 11, wherein the configuration information comprises an indication that one or more timers are not be started in a first symbol after an end of a PUSCH transmission.

13. (canceled)

14. A method performed by a user equipment (UE), the method comprising:
receiving a notification including configuration information comprising an uplink configured grant (CG) configuration and an indication of whether to start one or more timers in response to an uplink transmission on physical uplink shared channel (PUSCH) resources of the uplink CG configuration.

15. The method of claim 14, wherein the one or more timers comprise a drx-HARQ-RTT-TimerUL timer.

16. The method of claim 14, wherein the configuration information comprises an indication that the one or more timers are not to be started in response to the uplink transmission on the CG PUSCH resources.

17. The method of claim 16, wherein the configuration information comprises an indication that one or more timers are not be started in a first symbol after an end of a PUSCH transmission.

18. (canceled)

19. (canceled)

20. (canceled)

21. The UE of claim 1, wherein the notification including the configuration information is received via one or more of radio resource control (RRC) or physical downlink control channel (PDCCH).

22. A processor for wireless communication, comprising:
at least one controller coupled with at least one memory and configured to cause the processor to:
receive a notification including configuration information comprising an uplink configured grant (CG) configuration and an indication of whether to start one or more timers in response to an uplink transmission on physical uplink shared channel (PUSCH) resources of the uplink CG configuration.

23. The processor of claim 22, wherein the one or more timers comprise a drx-HARQ-RTT-TimerUL timer.

24. The processor of claim 22, wherein the configuration information comprises an indication that the one or more timers are not to be started in response to the uplink transmission on the CG PUSCH resources.

25. The processor of claim 22, wherein the configuration information comprises an indication that one or more timers are not be started in a first symbol after an end of a PUSCH transmission.
